(19) United States
(12) Patent Application Publication
(10) Pub. No.: US 2005/0187136 A1
(43) Pub. Date: Aug. 25, 2005

(54) Portioned detergent compositions comprising phosphate II

(76) Inventors: Ulrich Pegelow, Duesseldorf (DE); Alexander Lambotte, Duesseldorf (DE); Maren Jekel, Barcelona (ES); Christian Nitsch, Duesseldorf (DE); Arno Dueffels, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 11/057,617

(22) Filed: Feb. 14, 2005

Related U.S. Application Data
(63) Continuation of application No. PCT/EP03/08537, filed on Aug. 1, 2003.

(30) Foreign Application Priority Data
Aug. 14, 2002 (DE) 102 37 198 9

(51) Int. Cl. C11D 17/00

(52) U.S. Cl. 510/510

(57) ABSTRACT

A portioned liquid detergent composition in a water-soluble or water-dispersible container, comprising a low-water matrix and phosphate particles dispersed therein, wherein the dispersed phosphate comprises sodium tripolyphosphate comprising less than 25% weight of phase I sodium tripolyphosphate, based on the total weight of the dispersed sodium tripolyphosphate.

### CROSS REFERENCE TO RELATED APPLICATIONS

This application is a continuation under 35 U.S.C. § 365(c) and 35 U.S.C. § 120 of international application PCT/EP2003/008537, filed on Aug. 1, 2003, and claims priority under 35 U.S.C. § 119 of DE 102 37 198.9, filed Aug. 14, 2002, each of which is incorporated in its entirety by reference herein.

### BACKGROUND OF THE INVENTION

The present invention lies in the field of portioned liquid detergents, as are used for metering washing and cleaning substances. In particular, the present invention relates to low-water liquid detergents which comprise phosphate.

Owing to their simple and reliable handling, portioned and predosed detergents are enjoying great popularity among consumers. The packaging of liquid or gel-form washing or cleaning substances or substance mixtures in water-soluble or water-dispersible materials is accordingly described in the prior art in a series of documents. In this context, a distinction is to be drawn between process applications for the production of the water-soluble or water-dispersible packages on the one hand and applications regarding the packaging materials and ingredients used on the other.

Specific embodiments of the thermoforming process for processing thermoformed packaging units are disclosed, for example, by the international patent applications WO 00/55044, WO 00/44045, WO 00/44046 and WO 00/55415 (Hindustan Lever Limited). According to the description of these applications, these thermoformed pouches contain liquid or gel-form substance mixtures, preferably from the field of washing and cleaning substances. The film pouch may consist of water-soluble materials such as polyvinyl alcohol. The applications do not give any detailed information about the composition of the liquid or gel-form ingredients, their storage stability or water absorption behavior.

The international patent application WO 02/16205 (Reckitt Benckiser Limited) provides a process for producing water-soluble vessels by thermoforming a water-soluble PVA film having a water content below 5% by weight. The resulting vessels are preferably filled with washing or cleaning substances, these preferably having a water content above 8% by weight. According to the disclosure of this application, the detergents may comprise alkali metal phosphates.

The application WO 02/16206 (Reckitt Benckiser Limited) provides a process for producing inflated water-soluble containers by adding gas-releasing salts to the substances or substance mixtures present in the containers. These compositions may be, inter alia, phosphate-containing detergents.

Liquid compositions having a water content above 3% by weight, which are packaged in thermoformed PVA containers, are claimed by the international patent application WO 02/16222 (Reckitt Benckiser Limited). The liquid compositions may, inter alia, be phosphate-containing textile or dishwasher detergents. None of the applications mentioned gives any information about the incorporation of the phosphates present in the liquid detergents or the advantageous influence of such an incorporation on storage stability and water absorption behavior of the phosphate-containing detergent.

WO 02/16541 (Reckitt Benckiser Limited) provides liquid-filled water-soluble or water-dispersible containers. The liquids present have a water content between 20 and 50% by weight and comprise at least one polyphosphate builder and also potassium and sodium ions, the molar ratio of potassium to sodium being between 0.55:1 and 20:1. The preferred polyphosphate disclosed is potassium tripolyphosphate. There are no further details of the phosphates used with preference or the incorporation thereof in this application.

The European patent EP 518 689 B1 (Rhone-Poulenc Agrochimie) claims container systems comprising a water-soluble or water-dispersible pouch comprising a composition which is a liquid or gel and comprises a dangerous product, from 5 to 55% by weight of water and an effective amount of an electrolyte which is an inorganic salt. According to the teaching of EP 518 689 B1, the addition of this electrolyte brings about the lowering of the solubility of the pouch material in the aqueous solution and in this way increases the stability of the pouch. In addition to other inorganic salts, phosphates are also disclosed as effective electrolytes. This patent does not give any information about the specific nature of these phosphates or the incorporation thereof.

Liquid or gel-form supply forms, as are obtainable predosed in film pouches and are described in the applications above, have hitherto had a series of disadvantages. For instance, especially low-water liquids or gels tend, at the temperatures and atmospheric moisture contents customary for storage, transport or use, to form precipitates up to and including solidification of the entire gel. The formation of such precipitates is not only detrimental to the outward appearance of the compositions, but also has a disadvantageous influence on the washing or cleaning performance of these compositions, since reduced solubility of the solidified detergent ingredients generally results from the precipitation.

It is consequently an object of the present invention to provide low-water liquid or gel-form supply forms of detergents which are suitable for packaging in water-soluble or water-dispersible films, and exhibit no precipitation or solidification even after storage for several weeks under the conditions (temperature, atmospheric moisture) customary for production, storage and transport of these compositions.

It has now been found that low-water liquid detergent compositions packaged in water-soluble or water-dispersible containers have a high storage stability when these compositions comprise sodium tripolyphosphate having a phase I fraction of below 25% by weight.

### DESCRIPTION OF THE INVENTION

The present invention therefore firstly provides a portioned liquid detergent composition in a water-soluble or water-dispersible container, comprising a low-water matrix and phosphate dispersed therein, wherein the dispersed phosphate comprises sodium tripolyphosphate and the phase I fraction of the dispersed sodium tripolyphosphate based on the total weight of the dispersed sodium tripolyphosphate is less than 25% by weight, and it has been found in preferred embodiments, especially in storage experiments at temperatures above 50° C. over several weeks, to be particularly advantageous when the phase I fraction of the dispersed sodium tripolyphosphate in the inventive compositions is less than 20% by weight, preferably less than 16% by weight, more preferably less than 12% by weight and in particular less than 10% by weight, based in each case on the total weight of the dispersed sodium tripolyphosphate.

Sodium tripolyphosphate (pentasodium phosphate, Na₅P₃O₁₀) is a nonhygroscopic, white, water-soluble salt which is anhydrous or crystallizes with 6H₂O and has the general formula NaO—[P(O)(ONa)—O]ₙ—Na where n=3. In the case of the anhydrous modifications, a distinction has to be drawn between the crystalline phase I and phase II phosphates. At room temperature, about 17 g of the salt free of water of crystallization dissolve in 100 g of water, approx. 20 g at 60°, and around 32 g at 100°; after heating the solution to 100° for two hours, hydrolysis forms about 8% orthophosphate and 15% diphosphate. In the case of the preparation of pentasodium triphosphate, phosphoric acid is reacted with sodium carbonate solution or sodium hydroxide solution in a stoichiometric ratio, and the solution is dewatered by spraying. Similarly to Graham's salt and sodium diphosphate, pentasodium triphosphate dissolves many insoluble metal compounds (including lime soaps, etc.).

In the context of the present invention, “low-water” refers to those liquid detergent compositions which have a total water content, i.e. a content of free water and/or water in the form of water of hydration and/or water of constitution, below 18% by weight, based in each case on the total weight of the detergent composition without taking into account the water-soluble or water-dispersible container. The water content can be determined, for example, by Karl Fischer titration.

In the context of this application, preferred detergent compositions have a total water content, i.e. a content of free water and/or water in the form of water of hydration and/or water of constitution, between 0.1 and 15% by weight, preferably between 0.5 and 12% by weight, more preferably between 1 and 9% by weight and in particular between 2 and 6% by weight, based in each case on the detergent composition without taking into account the water-soluble or water-dispersible container. Even though the total water content (sum of the free water of constitution and of the water of hydration) of preferred inventive compositions is between 0.1 and 15% by weight, the proportion of free water in this total water content is preferably low. In the context of the present application, preference is therefore given to detergent compositions which have a content of free water, i.e. water not in the form of water of hydration and/or water of constitution, between 0.1 and 6% by weight, preferably between 0.1 and 5% by weight, more preferably between 0.1 and 4% by weight and in particular between 0.1 and 3% by weight, based in each case on the total weight of the detergent composition without taking into account the water-soluble or water-dispersible container.

Low-water detergents, preferred in the context of the present invention, comprise, in addition to the sodium tripolyphosphate described above, further phosphates, preferably from the group of the alkali metal phosphates. Alkali metal phosphates is the collective term for the alkali metal (especially sodium and potassium) salts of the different phosphoric acids, for which a distinction can be drawn of metaphosphoric acids (HPO₃)ₙ and orthophosphoric acid H₃PO₄ from higher molecular weight representatives. The phosphates combine several advantages: they function as alkali carriers, prevent limescale deposits and additionally contribute to the cleaning performance.

Sodium dihydrogenphosphate, NaH₂PO₄, exists as the dihydrate (density 1.91 gcm⁻³, melting point 60°) and as the monohydrate (density 2.04 gcm⁻³). Both salts are white powders which are very readily soluble in water, lose the water of crystallization upon heating and undergo conversion at 200° C. to the weakly acidic diphosphate (disodium hydrogendiphosphate, Na₂H₂P₂O₇), at a higher temperature to sodium trimetaphosphate (Na₃P₃O₉) and Maddrell's salt (see below). NaH₂PO₄ is acidic; it is formed when phosphoric acid is adjusted to a pH of 4.5 using sodium hydroxide solution and the slurry is sprayed. Potassium dihydrogenphosphate (primary or monobasic potassium phosphate, potassium diphosphate, PDP), KH₂PO₄, is a white salt of density 2.33 gcm⁻³, has a melting point of 2530 [decomposition with formation of potassium polyphosphate (KPO₃)ₓ] and is readily soluble in water.

Disodium hydrogenphosphate (secondary sodium phosphate), Na₂HPO₄, is a colorless, very readily water-soluble crystalline salt. It exists in anhydrous form and with 2 mol of water (density 2.066 gcm⁻³, water loss at 95°), 7 mol of water (density 1.68 gcm⁻³, melting point 48° with the loss of 5H₂O) and 12 mol of water (density 1.52 gcm⁻³, melting point 35° with loss of 5H₂O), becomes anhydrous at 100° and converts to the diphosphate Na₄P₂O₇ upon more intense heating. Disodium hydrogenphosphate is prepared by neutralizing phosphoric acid with sodium carbonate solution using phenolphthalein as an indicator. Dipotassium hydrogenphosphate (secondary or dibasic potassium phosphate), K₂HPO₄, is an amorphous white salt which is readily soluble in water.

Trisodium phosphate, tertiary sodium phosphate, Na₃PO₄, are colorless crystals which in the form of the dodecahydrate have a density of 1.62 gcm⁻³ and a melting point of 73-76° C. (decomposition), in the form of the decahydrate (corresponding to 19-20% of P₂O₅) have a melting point of 100° C., and in anhydrous form (corresponding to 39-40% of P₂O₅) have a density of 2.536 gcm⁻³. Trisodium phosphate is readily soluble in water with an alkaline reaction and is prepared by evaporatively concentrating a solution of exactly 1 mol of disodium phosphate and 1 mol of NaOH. Tripotassium phosphate (tertiary or tribasic potassium phosphate), K₃PO₄, is a white, deliquescent, granular powder of density 2.56 gcm⁻³, has a melting point of 1340° and is readily soluble in water with an alkaline reaction. It is formed, for example, when Thomas slag is heated with charcoal and potassium sulfate. Despite the higher price, the more readily soluble and therefore highly effective potassium phosphates are often preferred in the detergents industry over the corresponding sodium compounds.

Tetrasodium diphosphate (sodium pyrophosphate), Na₄P₂O₇, exists in anhydrous form (density 2.534 gcm³, melting point 988°, 880° also reported) and as the decahydrate (density 1.815-1.836 gcm⁻³, melting point 94° with loss of water). Both substances are colorless crystals which are soluble in water with an alkaline reaction. Na₄P₂O₇ is formed when disodium phosphate is heated at >200° or by reacting phosphoric acid with sodium carbonate in the stoichiometric ratio and dewatering the solution by spraying. The decahydrate complexes heavy metal salts and water hardness constituents and therefore reduces the hardness of the water. Potassium diphosphate (potassium pyrophosphate), K₄P₂O₇, exists in the form of the trihydrate and is a colorless, hygroscopic powder with a density of 2.33 gcm⁻³ which is soluble in water, the pH of the 1% solution at 25° being 10.4.

Condensation of the NaH₂PO₄ or of the KH₂PO₄ gives rise to higher molecular weight sodium and potassium phosphates, for which a distinction can be drawn between cyclic representatives, the sodium and potassium metaphosphates, and catenated types, the sodium and potassium polyphosphates. Especially for the latter, a multitude of names are in use: fused or calcined phosphates, Graham's salt, Kurrol's and Maddrell's salt. All higher sodium and potassium phosphates are referred to collectively as condensed phosphates.

Pentapotassium triphosphate, K₅P₃O₁₀ (potassium tripolyphosphate), is commercially available, for example, in the form of a 50% by weight solution (>23% P₂O₅, 25% K₂O). The potassium polyphosphates are widely used in the detergent industry.

In the context of the present invention, all of the aforementioned phosphates are to be regarded as preferred constituents of liquid low-water detergent compositions, the dispersed phosphate comprising, in a particularly preferred embodiment of the present invention, in addition to the sodium tripolyphosphate, further polyphosphate(s), preferably tripolyphosphate(s), more preferably potassium tripolyphosphate.

The claimed compositions may not only be heavy-duty detergents for textiles or machine dishwasher detergents but also specialty detergents for the care of fibers, glass, ceramic or metal. In any case, preference is given to detergents which have a total phosphate content of the detergent composition between 30 and 70% by weight, preferably between 35 and 65% by weight, more preferably between 40 and 60% by weight and in particular between 45 and 55% by weight, based in each case on the total weight of the liquid detergent composition without taking into account the water-soluble or water-dispersible container.

To influence the solution properties or the appearance of the claimed detergents, but in particular to further improve the storability, the phosphate dispersed in the low-water matrix may be coated. It is preferred that at least 10% by weight, preferably at least 30% by weight, more preferably at least 50% by weight and in particular at least 70% by weight, of the dispersed phosphate, based on the total weight of the dispersed phosphate, has a coating.

Suitable coating materials or constituents of the coating, for example binders in combination with salts, preferably inorganic salts, are in particular polymers or polymer mixtures, the polymer or at least 50% by weight of the polymer mixture being selected from the
a) water-soluble nonionic polymers from the group of
a1) polyvinylpyrrolidones,
a2) vinylpyrrolidone-vinyl ester copolymers,
a3) cellulose ethers
b) water-soluble amphoteric polymers from the group of
b1) alkylacrylamide-acrylic acid copolymers
b2) alkylacrylamide-methacrylic acid copolymers
b3) alkylacrylamide-methylmethacrylic acid copolymers
b4) alkylacrylamide-acrylic acid-alkylaminoalkyl(meth)acrylic acid copolymers
b5) alkylacrylamide-methacrylic acid-alkylaminoalkyl(meth)acrylic acid copolymers
b6) alkylacrylamide-methylmethacrylic acid-alkylaminoalkyl(meth)acrylic acid copolymers
b7) alkylacrylamide-alkyl methacrylate-alkylaminoethyl methacrylate-alkyl methacrylate copolymers
b8) copolymers of
   b8i) unsaturated carboxylic acids
   b8ii) cationically derivatized unsaturated carboxylic acids
   b8iii) if desired, further ionic or nonionogenic monomers
c) water-soluble zwitterionic polymers from the group of
c1) acrylamidoalkyltrialkylammonium chloride-acrylic acid copolymers and their alkali metal and ammonium salts
c2) acrylamidoalkyltrialkylammonium chloride-methacrylic acid copolymers and their alkali metal and ammonium salts
c3) methacroylethyl betaine-methacrylate copolymers
d) water-soluble anionic polymers from the group of
d1) vinyl acetate-crotonic acid copolymers
d2) vinylpyrrolidone-vinyl acrylate copolymers
d3) acrylic acid-ethyl acrylate-N-tert-butylacrylamide terpolymers
d4) graft polymers of vinyl esters, esters of acrylic acid or methacrylic acid alone or in a mixture, copolymerized with crotonic acid, acrylic acid or methacrylic acid with polyalkylene oxides and/or polyalkylene glycols
d5) grafted and crosslinked copolymers from the copolymerization of
   d5i) at least one monomer of the nonionic type,
   d5ii) at least one monomer of the ionic type,
   d5iii) polyethylene glycol, and
   d5iv) a crosslinker
d6) copolymers obtained by copolymerizing at least one monomer from each of the three following groups:
   d6i) esters of unsaturated alcohols and short-chain saturated carboxylic acids and/or esters of short-chain saturated alcohols and unsaturated carboxylic acids,
   d6ii) unsaturated carboxylic acids,
   d6iii) esters of long-chain carboxylic acids and unsaturated alcohols and/or esters of the carboxylic acids of group d6ii) with saturated or unsaturated, straight-chain or branched C₈₋₁₈ alcohol
d7) terpolymers of crotonic acid, vinyl acetate and an allyl or methallyl ester
d8) tetra- and pentapolymers of
   d8i) crotonic acid or allyloxyacetic acid
   d8ii) vinyl acetate or vinyl propionate
   d8iii) branched allyl or methallyl esters
   d8iv) vinyl ethers, vinyl esters or straight-chain allyl or methallyl esters
d9) crotonic acid copolymers with one or more monomers from the group consisting of ethylene, vinylbenzene, vinyl methyl ether, acrylamide, and water-soluble salts thereof
d10) terpolymers of vinyl acetate, crotonic acid, and vinyl esters of a saturated aliphatic α-branched monocarboxylic acid
e) water-soluble cationic polymers from the group of
e1) quaternized cellulose derivatives
e2) polysiloxanes with quaternary groups
e3) cationic guar derivatives
e4) polymeric dimethyldiallylammonium salts and their copolymers with esters and amides of acrylic acid and methacrylic acid
e5) copolymers of vinylpyrrolidone with quaternized derivatives of dialkylaminoacrylate and -methacrylate
e6) vinylpyrrolidone-methoimidazolinium chloride copolymers
e7) quaternized polyvinyl alcohol
e8) polymers indicated under the INCI designations Polyquaternium 2, Polyquaternium 17, Polyquaternium 18, and Polyquaternium 27.

Water-soluble polymers in the context of the invention are those polymers which are soluble in water to an extent of more than 2.5% by weight at room temperature.

The phosphates dispersed in the inventive liquid detergents are preferably coated with a polymer or polymer mixture, the polymer (and accordingly the overall mixture) or at least 50% by weight of the polymer mixture (and thus at least 50% of the coating) being selected from certain polymers. The coating consists entirely or to an extent of at least 50% of its weight of water-soluble polymers from the group of the nonionic, amphoteric, zwitterionic, anionic and/or cationic polymers. In a further preferred embodiment, the coating of the phosphate consists of a further inorganic salt which comprises one of the polymers mentioned as a binder. Preferred polymers from these groups have been listed above and are described in detail below.

Water-soluble polymers which are preferred in accordance with the invention are nonionic. Examples of suitable nonionogenic polymers are:
polyvinylpyrrolidones, as sold, for example, under the name Luviskol® (BASF). Polyvinylpyrrolidones are preferred nonionic polymers in the context of the invention.
Polyvinylpyrrolidones [poly(1-vinyl-2-pyrrolidinones)], abbreviated PVP, are polymers of the general formula (I) 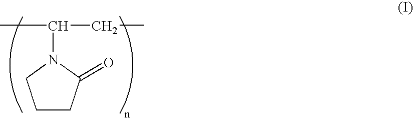
which are prepared by free-radical polymerization of 1-vinylpyrrolidone by processes of solution or suspension polymerization using free-radical initiators (peroxides, azo compounds). The ionic polymerization of the monomer affords only products having low molar masses. Commercial polyvinylpyrrolidones have molar masses in the range of approx. 2500-750,000 g/mol, which are characterized by specifying the K values and, depending on the K value, have glass transition temperatures of 130-175°. They are supplied as white, hygroscopic powders or as aqueous solutions. Polyvinylpyrrolidones are readily soluble in water and a multitude of organic solvents (alcohols, ketones, glacial acetic acid, chlorohydrocarbons, phenols, etc).
Vinylpyrrolidone-vinyl ester copolymers, as sold, for example, under the trademark Luviskol® (BASF). Luviskol® VA 64 and Luviskol® VA 73, each vinylpyrrolidone-vinyl acetate copolymers, are particularly preferred nonionic polymers. The vinyl ester polymers are polymers obtainable from vinyl esters and featuring the moiety of the formula (II) 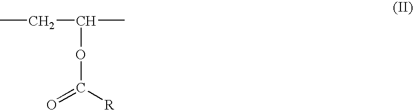
as the characteristic basic structural unit of the macromolecules. Of these, the vinyl acetate polymers (R=CH₃) with polyvinyl acetates have the greatest industrial significance as by far the most important representatives.
The vinyl esters are polymerized free-radically by various processes (solution polymerization, suspension polymerization, emulsion polymerization, bulk polymerization). Copolymers of vinyl acetate with vinylpyrrolidone contain monomer units of the formulae (I) and (II)
Cellulose ethers, such as hydroxypropylcellulose, hydroxyethylcellulose and methylhydroxypropylcellulose, as sold, for example, under the trademarks Culminal® and Benecel® (AQUALON).
Cellulose ethers can be described by the general formula (III) 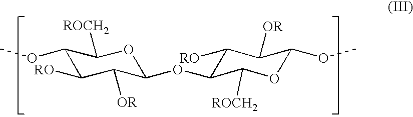
   in which R is H or an alkyl, alkenyl, alkynyl, aryl or alkylaryl radical. In preferred products, at least one R in formula (III) is —CH₂CH₂CH₂—OH or —CH₂CH₂—OH. Cellulose ethers are prepared industrially by etherifying alkali metal cellulose (for example with ethylene oxide). Cellulose ethers are characterized by way of the average degree of substitution, DS, and/or by the molar degree of substitution, MS, which indicate how many hydroxyl groups of an anhydroglucose unit of cellulose have reacted with the etherifying reagent or how many moles of the etherifying reagent have been added, on average, to one anhydroglucose unit. Hydroxyethylcelluloses are water-soluble above a DS of approx. 0.6 or an MS of approx. 1. Commercial hydroxyethyl- and hydroxypropylcelluloses have degrees of substitution in the range of 0.85-1.35 (DS) and 1.5-3 (MS). Hydroxyethyl- and -propylcelluloses are sold as yellowish-white, odorless and tasteless powders in highly varying degrees of polymerization. Hydroxyethyl- and -propylcelluloses are soluble in cold and hot water and in some (aqueous) organic solvents, but insoluble in the majority of (anhydrous) organic solvents; their aqueous solutions are relatively insensitive to changes in pH or addition of electrolyte.

Further polymers preferred in accordance with the invention are water-soluble amphopolymers. The generic term amphopolymers embraces amphoteric polymers, i.e. polymers which include both free amino groups and free —COOH or SO₃H groups in the molecule and which are capable of forming internal salts; zwitterionic polymers whose molecule includes quaternary ammonium groups and —COO⁻ or —SO₃⁻ groups, and those polymers which contain —COOH or SO₃H groups and quaternary ammonium groups. An example of an amphopolymer which can be used in accordance with the invention is the acrylic resin obtainable under the name Amphomer®, which is a copolymer of tert-butylaminoethyl methacrylate, N-(1,1,3,3-tetramethylbutyl)acrylamide, and two or more monomers from the group consisting of acrylic acid, methacrylic acid and their simple esters. Likewise preferred amphopolymers are composed of unsaturated carboxylic acids (e.g. acrylic and methacrylic acid), cationically derivatized unsaturated carboxylic acids (e.g. acrylamidopropyltrimethylammonium chloride) and, if desired, further ionic or nonionogenic monomers, as can be taken, for example, from DE-A 39 29 973 and the prior art cited therein. Terpolymers of acrylic acid, methyl acrylate and methacrylamidopropyltrimonium chloride, as obtainable commercially under the name Merquat® 2001 N, are particularly preferred amphopolymers in accordance with the invention. Further suitable amphoteric polymers are, for example, the octylacrylamide-methyl methacrylate-tert-butylaminoethyl methacrylate-2-hydroxy-propyl methacrylate copolymers available under the names Amphomer® and Amphomer® LV-71 (DELFT NATIONAL).

Suitable zwitterionic polymers are, for example, acrylamidopropyltrimethylammonium chloride-acrylic acid or -methacrylic acid copolymers and their alkali metal salts and ammonium salts. Further suitable zwitterionic polymers are methacryloylethyl betaine-methacrylate copolymers, which are obtainable commercially under the name Amersette® (AMERCHOL).

Anionic polymers suitable in accordance with the invention include:
Vinyl acetate-crotonic acid copolymers, as commercially available, for example, under the names Resyn® (NATIONAL STARCH), Luviset® (BASF) and Gafset® (GAF).
In addition to monomer units of the abovementioned formula (II), these polymers also have monomer units of the general formula (IV):
   [—CH(CH₃)—CH(COOH)—]ₙ (IV)
Vinylpyrrolidone-vinyl acrylate copolymers, obtainable for example under the trademark Luviflex® (BASF). A preferred polymer is the vinylpyrrolidone-acrylate terpolymer obtainable under the name Luviflex® VBM-35 (BASF).
Acrylic acid-ethyl acrylate-N-tert-butylacrylamide terpolymers, which are sold, for example, under the name Ultrahold® strong (BASF).
Graft polymers of vinyl esters, esters of acrylic acid or methacrylic acid alone or in a mixture, copolymerized with crotonic acid, acrylic acid or methacrylic acid with polyalkylene oxides and/or polyalkylene glycols
Such grafted polymers of vinyl esters, esters of acrylic acid or methacrylic acid alone or in a mixture with other copolymerizable compounds onto polyalkylene glycols are obtained by polymerization under hot conditions in homogeneous phase, by stirring the polyalkylene glycols into the monomers of the vinyl esters, esters of acrylic acid or methacrylic acid, in the presence of free-radical initiators.
Suitable vinyl esters have been found to be, for example, vinyl acetate, vinyl propionate, vinyl butyrate, vinyl benzoate, and suitable esters of acrylic acid or methacrylic acid have been found to be those which are obtainable with low molecular weight aliphatic alcohols, i.e., in particular, ethanol, propanol, isopropanol, 1-butanol, 2-butanol, 2-methyl-1-propanol, 2-methyl-2-propanol, 1-pentanol, 2-pentanol, 3-pentanol, 2,2-dimethyl-1-propanol, 3-methyl-1-butanol, 3-methyl-2-butanol, 2-methyl-2-butanol, 2-methyl-1-butanol, 1-hexanol.
Useful polyalkylene glycols include in particular polyethylene glycols and polypropylene glycols. Polyethylene glycols are polymers of ethylene glycol which satisfy the general formula V
   H—(O—CH₂—CH₂)ₙ—OH (V)
in which n may assume values between 1 (ethylene glycol) and several thousand. For polyethylene glycols there exist various nomenclatures, which may lead to confusion. It is common practice in industry to specify the average relative molar weight after “PEG”, so that “PEG 200” characterizes a polyethylene glycol having a relative molar mass of approx. 190 to approx. 210. For cosmetic ingredients, a different nomenclature is used, in which the abbreviation PEG is followed by a hyphen which is followed directly by a number which corresponds to the number n in the abovementioned formula V. According to this nomenclature (known as the INCI nomenclature, CTFA International Cosmetic Ingredient Dictionary and Handbook, 5th Edition, The Cosmetic, Toiletry and Fragrance Association, Washington, 1997), for example, PEG-4, PEG-6, PEG-8, PEG-9, PEG-10, PEG-12, PEG-14 and PEG-16 may be used. Polyethylene glycols are available commercially, for example, under the trade names Carbowax® PEG 200 (Union Carbide), Emkapol® 200 (ICI Americas), Lipoxol® 200 MED (HÜLS America), Polyglycol® E-200 (Dow Chemical), Alkapol® PEG 300 (Rhóne-Poulenc), Lutrol® E300 (BASF), and the corresponding trade names with higher numbers.
Polypropylene glycols (abbreviation PPGs) are polymers of propylene glycol which satisfy the general formula VI 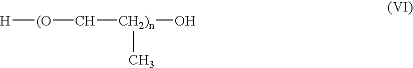
in which n may assume values between 1 (propylene glycol) and several thousand. Of industrial significance here are in particular di-, tri-, and tetrapropylene glycol, i.e., the representatives where n=2, 3 and 4 in formula VI.
In particular, it is possible to use the vinyl acetate copolymers grafted onto polyethylene glycols and the polymers of vinyl acetate and crotonic acid grafted onto polyethylene glycols.
Grafted and crosslinked copolymers from the copolymerization of
i) at least one monomer of the nonionic type,
ii) at least one monomer of the ionic type,
iii) polyethylene glycol, and
iv) a crosslinker
The polyethylene glycol used has a molecular weight of between 200 and several million, preferably between 300 and 30,000. The nonionic monomers may be of very different types and preference is given among them to the following: vinyl acetate, vinyl stearate, vinyl laurate, vinyl propionate, allyl stearate, allyl laurate, diethyl maleate, allyl acetate, methyl methacrylate, cetyl vinyl ether, stearyl vinyl ether, and 1-hexene. The ionic monomers may equally be of very different types, and particular preference among these is given to the presence in the graft polymers of crotonic acid, allyloxyacetic acid, vinylacetic acid, maleic acid, acrylic acid, and methacrylic acid.
Preferred crosslinkers are ethylene glycol dimethacrylate, diallyl phthalate, ortho-, meta- and para-divinylbenzene, tetraallyloxyethane, and polyallylsaccharoses containing 2 to 5 allyl groups per molecule of saccharin.
The above-described grafted and crosslinked copolymers are formed preferably from:
i) from 5 to 85% by weight of at least one monomer of the nonionic type,
ii) from 3 to 80% by weight of at least one monomer of the ionic type,
iii) from 2 to 50% by weight, preferably from 5 to 30% by weight, of polyethylene glycol, and
iv) from 0.1 to 8% by weight of a crosslinker, the percentage of the crosslinker depending on the ratio of the overall weights of i), ii) and iii).
Copolymers obtained by copolymerizing at least one monomer from each of the three following groups:
i) esters of unsaturated alcohols and short-chain saturated carboxylic acids and/or esters of short-chain saturated alcohols and unsaturated carboxylic acids,
ii) unsaturated carboxylic acids,
iii) esters of long-chain carboxylic acids and unsaturated alcohols and/or esters of the carboxylic acids of group ii) with saturated or unsaturated, straight-chain or branched C₈₋₁₈ alcohol.
Short-chain carboxylic acids and alcohols in this context are those having from 1 to 8 carbon atoms, and the carbon chains of these compounds may optionally be interrupted by divalent heteroatomic groups such as —O—, —NH—, and —S—.
Terpolymers of crotonic acid, vinyl acetate, and an allyl or methallyl ester These terpolymers contain monomer units of the general formulae (II) and (IV) (see above) and also monomer units of one or more allyl or methallyl esters of the formula VII: 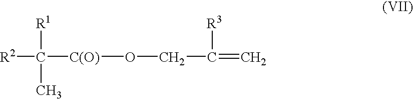
where R³ is —H or —CH₃, R² is —CH₃ or —CH(CH₃)₂ and R¹ is —CH₃ or a saturated straight-chain or branched C₁₋₆-alkyl radical and the sum of the carbon atoms in the radicals R¹ and R² is preferably 7, 6, 5, 4, 3 or 2.
The aforementioned terpolymers result preferably from the copolymerization of from 7 to 12% by weight of crotonic acid, from 65 to 86% by weight, preferably from 71 to 83% by weight, of vinyl acetate and from 8 to 20% by weight, preferably from 10 to 17% by weight, of allyl or methallyl esters of the formula VIII.
Tetra- and pentapolymers of
i) crotonic acid or allyloxyacetic acid
ii) vinyl acetate or vinyl propionate
iii) branched allyl or methallyl esters
iv) vinyl ethers, vinyl esters or straight-chain allyl or methallyl esters.
Crotonic acid copolymers with one or more monomers from the group of ethylene, vinylbenzene, vinyl methyl ether, acrylamide and the water-soluble salts thereof.
Terpolymers of vinyl acetate, crotonic acid and vinyl esters of a saturated aliphatic α-branched monocarboxylic acid.

Further polymers which can be used with preference as coating constituents are cationic polymers. Among the cationic polymers, preference is given to the permanently cationic polymers. “Permanently cationic” refers in accordance with the invention to those polymers which, irrespective of the pH of the composition (i.e. both of the coating and of the tablet), have a cationic group. These are generally polymers which include a quaternary nitrogen atom, for example in the form of an ammonium group.

Preferred cationic polymers are, for example:
quaternized cellulose derivatives, as available commercially under the names Celquat® and Polymer JR®. The compounds Celquat® H 100, Celquat® L 200 and Polymer JR® 400 are preferred quaternized cellulose derivatives,
polysiloxanes with quaternary groups, for example the commercially available products Q2-7224 (manufacturer: Dow Corning; a stabilized trimethylsilylamodimethicone), Dow Corning® 929 emulsion (comprising a hydroxyamino-modified silicone, also referred to as amodimethicone), SM-2059 (manufacturer: General Electric), SLM-55067 (manufacturer: Wacker), and Abil®-Quat 3270 and 3272 (manufacturer: Th. Goldschmidt; diquaternary polydimethylsiloxanes, Quaternium-80),
cationic guar derivatives, such as in particular the products sold under the trade names Cosmedia® Guar and Jaguar®,
polymeric dimethyldiallylammonium salts and their copolymers with esters and amides of acrylic acid and methacrylic acid. The products available commercially under the names Merquate 100 (poly(dimethyldiallylammonium chloride)) and Merquate 550 (dimethyldiallylammonium chloride-acrylamide copolymer) are examples of such cationic polymers.
Copolymers of vinylpyrrolidone with quaternized derivatives of dialkylamino acrylate and methacrylate, for example diethyl sulfate-quaternized vinylpyrrolidone-dimethylamino methacrylate copolymers. Such compounds are available commercially under the names Gafquat® 734 and Gafquat® 755.
Vinylpyrrolidone-methoimidazolinium chloride copolymers, as supplied under the name Luviquat®.
Quaternized polyvinyl alcohol
   and also polymers known under the names
Polyquaternium 2
Polyquaternium 17,
Polyquaternium 18, and
Polyquaternium 27,
   having quaternary nitrogen atoms in the polymer main chain. These polymers are designated in accordance with the INCI nomenclature; detailed information can be found in the CTFA International Cosmetic Ingredient Dictionary and Handbook, 5th Edition, The Cosmetic, Toiletry and Fragrance Association, Washington, 1997, which is expressly incorporated herein by reference.

Cationic polymers which are preferred in accordance with the invention are quaternized cellulose derivatives and also polymeric dimethyldiallylammonium salts and copolymers thereof. Cationic cellulose derivatives, especially the commercial product Polymer® JR 400, are very particularly preferred cationic polymers.

A particularly preferred coating material in the context of the present application for phosphates is polyvinyl alcohol (PVA). With regard to the degree of hydrolysis and the molecular weight of the polyvinyl alcohols used with preference for the coating, the remarks made below in the description with regard to the preferred container materials to which reference is made at this point to avoid repetitions apply.

As already mentioned, the coating of phosphates preferred in accordance with the invention may also consist of a mixture of the aforementioned polymers with salts, preferably inorganic salts.

Such coated phosphate particles can be prepared, for example, by a granulation process in which particulate builders in a fluidized bed are contacted with binder-containing aqueous solutions of inorganic salts. Such a process for preparing coated phosphate particles comprises the steps of:
a) introducing one or more particulate builder(s) into a fluidized bed;
b) spraying the aqueous solution of at least one inorganic salt onto the particulate builder(s), the aqueous solution used in step b) also comprising a binder.

In the context of the present application, particles or particulate builder granules refer to separate particles, as are obtained, for example, by crystallization or agglomeration. The term particles is not bound to any particle size. The size of the particles processed in the process according to the invention is restricted exclusively by the technical possibilities of the fluidized bed used.

The coating composition used in step b) of the process is an aqueous solution of an inorganic salt which also comprises binders. The binder used is not necessarily dissolved fully, and it may, for example, also be suspended in the aqueous phases. However, preference is given in the context of the present application to coating compositions which comprise both the inorganic salt and the binder in dissolved form.

To carry out the coating process, it has been found to be advantageous to control the temperature of the air supply, of the fluidized bed and of the sprayed aqueous solution. Preference is therefore given in the context of the present application to processes according to the invention in which the temperature of the air supply used in step b) is between 30 and 220° C., preferably between 60 and 210° C. and in particular between 90 and 200° C., and/or the fluidized bed during the spraying of the aqueous solution in step b) at a temperature above 30° C., preferably above 45° C. and in particular above 60° C., and/or the aqueous solution sprayed in step b) has a temperature above 30° C., preferably above 40° C. and in particular above 50° C.

In the context of the above process, preference is given to using aqueous solutions of inorganic salts which have a solubility above 100 g/l at 20° C. Advantageously useable inorganic salts have been found to be in particular those salts which are capable of forming hydrates. From this group of the hydrate-forming salts, preference is given in turn to sodium sulfate, sodium carbonate, sodium phosphate or magnesium sulfate. Particular preference is given to granulation processes, which are wherein the solution sprayed in step b) comprises at least one inorganic salt from the group which is capable of forming hydrates, in particular at least one inorganic salt from the group of sodium sulfate, sodium carbonate, sodium phosphate and magnesium sulfate.

The above inorganic salts are used in the process according to the invention in the form of aqueous solutions which additionally comprise a binder. The use of this/these binder(s) in the process according to the invention increases the bulk density and attrition resistance of the resulting granules, and improves their flowability.

Particularly suitable binders have been found to be water-soluble organic polymers, of which particular preference is given to the polyalkylene glycols, in particular polyethylene glycols and/or polypropylene glycols. A comprehensive description of preferred water-soluble polymers for the coating can be found in the preceding sections. Reference is made to these remarks at this point.

The coating, preferred in the context of the present invention, of the phosphate dispersed in the inventive liquid detergent compositions leads, even at small amounts of coating material, to distinctly improved properties of these compositions. It is preferred in the context of the present invention that the amount of coating material, based on the total weight of the coated dispersed phosphate, is between 0.5 and 15% by weight, preferably between 1 and 12% by weight and in particular between 2 and 0.8% by weight.

A second method for improving the storability of inventive compositions, in addition to the coating described above, is the hydration of the phosphates, in particular of the sodium tripolyphosphate, dispersed in the low-water matrix. As mentioned at the outset, sodium tripolyphosphate exists not only in the two anhydrous modifications but also as the crystalline hexahydrate, whose water of hydration content, based on the total weight, is 28% by weight. In a further preferred embodiment, the dispersed sodium tripolyphosphate is therefore present at least partly in the form of the hexahydrate. However, the dispersed sodium tripolyphosphate may also be present fully in the form of the hexahydrate. Particular preference is given to detergent compositions in which the dispersed sodium tripolyphosphate, based on its total weight, contains from 10 to 70% by weight, preferably from 20 to 60% by weight and in particular from 25 to 50% by weight, of sodium tripolyphosphate hexahydrate. Instead of, or in combination with, the fully hydrated sodium tripolyphosphate hexahydrate, partly hydrated sodium tripolyphosphate may also be used. Compared to the hexahydrate, such partly hydrated phosphate has the advantage of easier processability and, owing to the lower water of hydration content, enables the production of detergent compositions of higher active ingredient concentration. Partly hydrated sodium tripolyphosphate can be prepared, for example, by the action of hot steam or aqueous spray mist on anhydrous phosphates. The degree of hydration of the phosphate can be determined via the amount of water supplied. In the context of the present application, preferred detergent compositions comprise the dispersed phosphate at least partly in the form of a hydrated phosphate, this hydrated phosphate preferably having a water of hydration content of from 0.5 to 26% by weight, preferably of from 1 to 24% by weight and in particular of from 2 to 20% by weight, based in each case on the total weight of the dispersed hydrated phosphate.

The inventive compositions are present as a solid suspension in a low-water matrix which, apart from the water, may also comprise further nonaqueous solvents. In the context of the present invention, the term “solid suspension” does not rule out that the solid substances present in the inventive compositions are present at least partly in solution. However, irrespective of these dissolved fractions, the inventive compositions have a proportion of suspended solids. The abovementioned nonaqueous solvents stem, for example, from the groups of the monoalcohols, diols, triols and polyols, the ethers, esters and/or amides. Particular preference is given to nonaqueous solvents which are water-soluble, “water-soluble” solvents in the context of the present application being solvents which are fully miscible with water at room temperature, i.e. without a miscibility gap.

Nonaqueous solvents which may be used in the inventive compositions stem preferably from the group of mono- or polyhydric alcohols, alkanolamines or glycol ethers, as long as they are miscible with water in the specified concentration range. Preference is given to selecting the solvents from ethanol, n- or i-propanol, butanols, glycol, propane- or butanediol, glycerol, diglycol, propyl- or butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy-, ethoxy- or butoxytriglycol, 1-butoxy-2-propanol, 3-methyl-3-methoxybutanol, propylene glycol t-butyl ether and mixtures of these solvents.

A portioned detergent composition which is particularly preferred in the context of the present invention is wherein the content of nonaqueous solvent(s) in the detergent composition is from 0.1 to 70% by weight, preferably from 0.5 to 60% by weight, more preferably from 1 to 50% by weight, even more preferably from 2 to 40% by weight and in particular from 2.5 to 30% by weight, based in each case on the overall composition, preferred nonaqueous solvent(s) being selected from the group of the room temperature liquid nonionic surfactants, the polyethylene glycols, polypropylene glycols, glycerol, glyceryl carbonate, triacetin, ethylene glycol, propylene glycol, propylene carbonate, hexylene glycol, ethanol and n-propanol and/or isopropanol.

The room temperature liquid nonionic surfactants are described in detail below as washing or cleaning substances.

Polyethylene glycols (abbreviation PEG) which can be used in accordance with the invention are liquid at room temperature. PEGs are polymers of ethylene glycol which satisfy the general formula (VIII)
H—(O—CH₂—CH₂)ₙ—OH (VIII)
where n can assume values between 1 (ethylene glycol, see below) and approx. 16. For polyethylene glycols, there exist various nomenclatures, which can lead to confusion. It is common practice in industry to specify the average relative molar weight after “PEG”, so that “PEG 200” characterizes a polyethylene glycol having a relative molar mass of from approx. 190 to approx. 210. According to this nomenclature, the industrially conventional polyethylene glycols PEG 200, PEG 300, PEG 400 and PEG 600 can be used in the context of the present invention.

For cosmetic ingredients, a different nomenclature is used in which the abbreviation PEG is followed by a hyphen which is followed directly by a number which corresponds to the number n in the abovementioned formula. According to this nomenclature (known as INCI nomenclature, CTFA International Cosmetic Ingredient Dictionary and Handbook, 5th edition, The Cosmetic, Toiletry and Fragrance Association, Washington, 1997), PEG-4, PEG-6, PEG-8, PEG-9, PEG-10, PEG-12, PEG-14 and PEG-16, for example, can be used in accordance with the invention.

Polyethylene glycols are commercially available, for example, under the trade names Carbowax® PEG 200 (Union Carbide), Emkapol® 200 (ICI Americas), Lipoxol® 200 MED (Hüls America), Polyglycol® E-200 (Dow Chemical), Alkapol® PEG 300 (Rhóne-Poulenc), Lutrol® E300 (BASF), and the corresponding trade names with higher numbers.

Polypropylene glycols (abbreviation PPG) which can be used in accordance with the invention are polymers of propylene glycol which satisfy the general formula (II) 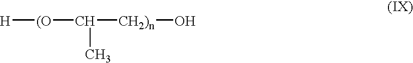
where n can assume values between 1 (propylene glycol, see below) and approx. 12. Of industrial importance here are in particular di-, tri- and tetrapropylene glycol, i.e. the representatives where n=2, 3 and 4 in the above formula.

Glycerol is a colorless, clear, low-mobility, odorless, sweet-tasting hygroscopic liquid of density 1.261, which solidifies at 18.2° C. Glycerol was originally just a by-product of fat hydrolysis, but is nowadays synthesized industrially in large amounts. Most industrial processes start from propene, which is processed via the allyl chloride and epichlorohydrin intermediates to give glycerol. A further industrial process is the hydroxylation of allyl alcohol with hydrogen peroxide over a WO₃ catalyst via the glycide stage.

Glyceryl carbonate is obtainable by transesterification of ethylene carbonate or dimethyl carbonate with glycerol to form ethylene glycol and/or methanol as by-products. A further synthetic route starts from glycidol (2,3-epoxy-1-propanol), which is reacted with CO₂ under pressure in the presence of catalysts to give glyceryl carbonate. Glyceryl carbonate is a clear, mobile liquid with a density of 1.398 gcm³, which boils at 125-130° C. (0.15 mbar).

Ethylene glycol (1,2-ethanediol, “glycol”) is a colorless, viscous, sweet-tasting, highly hygroscopic liquid which is miscible with water, alcohols and acetone and has a density of 1.113. The solidification point of ethylene glycol is −11.5° C.; the liquid boils at 198° C. Ethylene glycol is obtained industrially from ethylene oxide by heating with water under pressure. Promising preparative processes are also based on the acetoxylation of ethylene and subsequent hydrolysis or on synthesis gas reactions.

There exist two isomers of propylene glycol, 1,3-propanediol and 1,2-propanediol. 1,3-Propanediol (trimethylene glycol) is a neutral, colorless and odorless, sweet-tasting liquid of density 1.0597, which solidifies at −32° C. and boils at 214° C. 1,3-Propanediol is prepared from acrolein and water with subsequent catalytic hydrogenation.

Of considerably greater industrial importance is 1,2-propanediol (propylene glycol), which is an oily, colorless, virtually odorless liquid, which has a density of 1.0381 and which solidifies at −60° C. and boils at 188° C. 1,2-Propanediol is prepared from propylene oxide by an addition reaction of water.

Propylene carbonate is a clear, readily mobile liquid with a density of 1.21 gcm⁻³; the melting point is −49° C.; the boiling point is 242° C. Propylene carbonate is also obtainable on the industrial scale by reacting propylene oxide and CO₂ at 200° C. and 80 bar.

Apart from the above-described phosphate, detergent compositions preferred in accordance with the invention comprise further active substances customary for these compositions, particular preference being given to substances from the group of bleaches, bleach activators, polymers, builders, surfactants, enzymes, electrolytes, pH modifiers, fragrances, perfume carriers, dyes, hydrotropes, foam inhibitors, antiredeposition agents, optical brighteners, graying inhibitors, shrink preventatives, anticrease agents, dye transfer inhibitors, antimicrobial active ingredients, germicides, fungicides, antioxidants, corrosion inhibitors, antistats, repellency and impregnation agents, swelling and antislip agents, nonaqueous solvents, fabric softeners, protein hydrolyzates and UV absorbers.

As important constituents of detergents, bleaches and bleach activators may be present in the inventive compositions in addition to other constituents. Among the compounds which serve as bleaches and supply H₂O₂ in water, sodium perborate tetrahydrate and sodium perborate monohydrate are of particular significance. Further bleaches which can be used are, for example, sodium percarbonate, peroxypyrophosphates, citrate perhydrates, and H₂O₂-supplying peracidic salts or peracids, such as perbenzoates, peroxophthalates, diperazelaic acid, phthaloimino peracid or diperdodecanedioic acid. Detergent tablets for machine dishwashing may also comprise bleaches from the group of the organic bleaches. Typical organic bleaches are the diacyl peroxides, for example dibenzoyl peroxide. Further typical organic bleaches are the peroxy acids, particular examples being the alkyl peroxy acids and the aryl peroxy acids. Preferred representatives are (a) the peroxybenzoic acids and ring-substituted derivatives thereof, such as alkylperoxybenzoic acids, but it is also possible to use peroxy-α-naphthoic acid and magnesium monoperphthalate, (b) the aliphatic or substituted aliphatic peroxy acids, such as peroxylauric acid, peroxystearic acid, ε-phthalimido-peroxycaproic acid [phthaloiminoperoxy-hexanoic acid (PAP)], o-carboxybenzamidoperoxycaproic acid, N-nonenylamidoperadipic acid and N-nonenylamido-persuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid and N,N-terephthaloyldi(6-aminopercaproic acid).

When the inventive compositions are used as machine dishwasher detergents, they may comprise bleach activators in order to achieve improved bleaching action in the course of cleaning at temperatures of 60° C. and below. Bleach activators which may be used are compounds which, under perhydrolysis conditions, give aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified, and/or optionally substituted benzoyl groups. Preference is given to polyacylated alkylenediamines, in particular tetraacetylethylene-diamine (TAED), acylated triazine derivatives, in particular 1,5-diacetyl-2,4-dioxohexahydro-1, 3, 5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran.

Further bleach activators used with preference in the context of the present application are compounds from the group of cationic nitriles, in particular cationic nitrile of the formula 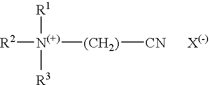
in which R¹ is —H, —CH₃, a C₂₋₂₄-alkyl or -alkenyl radical, a substituted C₂₋₂₄-alkyl or -alkenyl radical having at least one substituent from the group of —Cl, —Br, —OH, —NH₂, —CN, an alkyl- or alkenylaryl radical with a C₁₋₂₄-alkyl group, or is a substituted alkyl- or alkenylaryl radical having a C₁₋₂₄-alkyl group and at least one further substituent on the aromatic ring, R² and R³ are each independently selected from —CH₂—CN, —CH₃, —CH₂—CH₃, —CH₂—CH₂-CH₃, —CH(CH₃)—CH₃, —CH₂—OH, —CH₂—CH₂—OH, —CH(OH)—CH₃, —CH₂—CH₂-CH₂—OH, —CH₂—CH(OH)—CH₃, —CH(OH)—CH₂—CH₃, —(CH₂CH₂—O)ₙH where n=1, 2, 3, 4, 5 or 6 and X is an anion.

Particularly preferred inventive compositions comprise a cationic nitrile of the formula 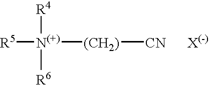
in which R⁴, R⁵ and R⁶ are each independently selected from —CH₃, —CH₂—CH₃, —CH₂—CH₂—CH₃, —CH(CH₃)—CH₃, where R⁴ may additionally also be —H and X is an anion, where preferably R⁵=R⁶=—CH₃ and in particular R⁴=R⁵=R⁶=—CH₃, particular preference being given to compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N⁽⁺⁾CH₂—CN X⁻, particular preference from the group of these substances being given in turn to the cationic nitrile of the formula (CH₃)₃N⁽⁺⁾CH₂—CN X⁻ in which X— is an anion which is selected from the group of chloride, bromide, iodide, hydrogensulfate, methosulfate, p-toluenesulfonate (tosylate) or xylenesulfonate.

In addition to the conventional bleach activators or in their stead, it is also possible to incorporate bleach catalysts into the compositions. These substances are bleach-boosting transition metal salts or transition metal complexes, for example salen or carbonyl complexes of Mn, Fe, Co, Ru or Mo. It is also possible to use. Mn, Fe, Co, Ru, Mo, Ti, V and Cu complexes with N-containing tripod ligands, and also Co-, Fe-, Cu- and Ru-ammine complexes as bleach catalysts.

In addition to the bleach and bleach activator ingredients mentioned, builders are further important ingredients of detergents. The inventive detergents may comprise all builders customarily used in these compositions, i.e. especially zeolites, silicates, carbonates, organic cobuilders and, where there are no ecological objections to their use, also the phosphates.

Suitable crystalline, sheet-type sodium silicates have the general formula NaMSiₓO₂ₓ₊₁H₂O where M is sodium or hydrogen, x is a number from 1.9 to 4, y is a number from 0 to 20, and preferred values for x are 2, 3 or 4. Preferred crystalline sheet silicates of the formula specified are those in which M is sodium and x assumes the values 2 or 3. In particular, preference is given to both β- and also δ-sodium disilicates Na₂Si₂O₅.yH₂O.

It is also possible to use amorphous sodium silicates having an Na₂O:SiO₂ modulus of from 1:2 to 1:3.3, preferably from 1:2 to 1:2.8 and in particular from 1:2 to 1:2.6, which have retarded dissolution and secondary washing properties. The retardation of dissolution relative to conventional amorphous sodium silicates may have been brought about in a variety of ways, for example by surface treatment, compounding, compacting or by overdrying. In the context of this invention, the term “amorphous” also includes “X-ray-amorphous”. This means that, in X-ray diffraction experiments, the silicates do not afford any sharp X-ray reflections typical of crystalline substances, but rather yield at best one or more maxima of the scattered X-radiation, which have a width of several degree units of the diffraction angle. However, it may quite possibly lead to even particularly good builder properties if the silicate particles in electron diffraction experiments yield vague or even sharp diffraction maxima. This is to be interpreted such that the products have microcrystalline regions with a size of from 10 to several hundred nm, and preference is given to values up to a maximum of 50 nm and in particular up to a maximum of 20 nm. Such X-ray-amorphous silicates likewise have retarded dissolution compared with conventional waterglasses. Particular preference is given to compacted amorphous silicates, compounded amorphous silicates and overdried X-ray-amorphous silicates.

The finely crystalline synthetic zeolite containing bound water which can be used is preferably zeolite A and/or P. The zeolite P is more preferably Zeolite MAP® (commercial product from Crosfield). Also suitable, however, are zeolite: X, and mixtures of A, X and/or P. Also commercially available and usable in accordance with the invention is, for example, a cocrystal of zeolite X and zeolite A, (about 80% by weight of zeolite X), which is sold by CONDEA Augusta S.p.A. under the trade name VEGOBOND AX® and can be described by the formula
nNa₂O.(1-n)K₂O.Al₂O₃.(2-2.5)SiO₂.(3.5-5.5) H₂O.

Suitable zeolites have an average particle size of less than 10 μm (volume distribution; measurement method: Coulter Counter) and preferably contain 18 to 22% by weight, in particular 20 to 22% by weight, of bound water.

It will be appreciated that it is also possible to use the commonly known phosphates as builder substances, as long as such a use is not to be avoided for ecological reasons. Especially suitable are the sodium salts of the orthophosphates, of the pyrophosphates and especially of the tripolyphosphates. To avoid repetitions, reference is made to the above remarks for a comprehensive description of these phosphates.

Organic builder substances which can be used are, for example, the polycarboxylic acids usable in the form of their alkali metal and especially sodium salts, such as citric acid, adipic acid, succinic acid, glutaric acid, tartaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

Alkali carriers may be present as further constituents. Alkali carriers include alkali metal hydroxides, alkali metal carbonates, alkali metal hydrogencarbonates, alkali metal sesquicarbonates, alkali metal silicates, alkali metal metasilicates and mixtures of the aforementioned substances, and particular preference is given in the context of this invention to using the alkali metal carbonates, especially sodium carbonate, sodium hydrogencarbonate or sodium sesquicarbonate.

When the inventive detergents are used for machine dishwashing, preference is given to water-soluble builders, since they generally have a lesser tendency to form insoluble residues on crockery and hard surfaces. Typical builders are the low molecular weight polycarboxylic acids and salts thereof, the homopolymeric and copolymeric polycarboxylic acids and salts thereof, the carbonates, phosphates and silicates. For the production of tablets for machine dishwashing, preference is given to using trisodium citrate and/or pentasodium tripolyphosphate and/or sodium carbonate and/or sodium bicarbonate and/or gluconates and/or silicatic builders from the class of the disilicates and/or metasilicates. Particular preference is given to a builder system comprising a mixture of tripolyphosphate and sodium carbonate. Particular preference is likewise given to a builder system which comprises a mixture of tripolyphosphate and sodium carbonate and sodium disilicate.

Organic cobuilders which may find use in the detergents in the context of the present invention are in particular polycarboxylates/polycarboxylic acids, polymeric polycarboxylates, aspartic acid, polyacetals, dextrins, further organic cobuilders (see below) and phosphonates. These substance classes are described below.

Organic builder substances which can be used are, for example, the polycarboxylic acids usable in the form of their sodium salts, polycarboxylic acids referring to carboxylic acids which bear more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, methylglycinediacetic acid; sugar acids and mixtures thereof.

The acids themselves may also be used. In addition to their builder action, the acids typically also have the property of an acidifying component and thus also serve to establish a lower and milder pH of detergents. In this connection, particular mention should be made of citric acid, succinic acid, glutaric acid, adipic acid, gluconic acid and any mixtures thereof.

Also suitable as builders are polymeric polycarboxylates; these are, for example, the alkali metal salts of polyacrylic acid or of polymethacrylic acid, for example those having a relative molecular mass of from 500 to 70,000 g/mol.

In the context of this document, the molar masses specified for polymeric polycarboxylates are weight-average molar masses M_{w}, of the particular acid form, always having been determined by means of gel-permeation chromatography (GPC) using a UV detector. The measurement was made against an external polyacrylic acid standard which, owing to its structural similarity to the polymers under investigation, affords realistic molar weight values. These figures deviate considerably from the molar weight data obtained when polystyrenesulfonic acids are used as the standard. The molar masses measured against polystyrenesulfonic acids are generally distinctly higher than the molar masses specified in this document.

Suitable polymers are in particular polyacrylates which preferably have a molecular mass of from 1000 to 20,000 g/mol. Owing to their superior solubility, preference within this group may be given in turn to the short-chain polyacrylates which have molar masses of from 1000 to 10,000 g/mol and more preferably from 1200 to 4000 g/mol.

In the inventive compositions, particular preference is given to using both polyacrylates and copolymers of unsaturated carboxylic acids, monomers containing sulfonic acid groups, and optionally further ionic or nonionogenic monomers. The copolymers containing sulfonic acid groups are described in detail below.

However, it is also possible to provide inventive products which, as what are known as “3-in-1” products, combine the conventional detergents, rinse aids and a salt replacement function. For this purpose, preference is given to inventive machine dishwasher detergents which additionally contain from 0.1 to 70% by weight of copolymers of
i) unsaturated carboxylic acids
ii) sulfonic acid group-containing monomers
iii) optionally further ionic or nonionogenic monomers.

These copolymers have the effect that the dishes treated with such compositions become distinctly cleaner in the course of subsequent cleaning operations than dishes which have been washed with conventional compositions.

As an additional positive effect, a decrease in the drying time of the dishes treated with the detergent occurs, i.e. the consumer can take the dishes out of the machine sooner and reuse them after the cleaning program has finished. In the context of the inventive teaching, drying time generally refers to the literal meaning, i.e. the time which elapses before a surface of dishes treated in a machine dishwasher has dried, but in particular the time which elapses until 90% of a surface treated with a detergent or rinse aid in concentrated or dilute form has dried.

In the context of the present invention, preferred monomers are unsaturated carboxylic acids of the formula X
R¹(R²)C=C(R³)COOH (X)
in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated straight-chain or branched hydrocarbon radical having from 1 to 12 carbon atoms.

Among the unsaturated carboxylic acids which can be described by the formula X, preference is given in particular to acrylic acid (R¹=R²=R³=H), methacrylic acid (R¹=R²=H; R³=CH₃) and/or maleic acid (R¹=COOH; R²=R³H).

The monomers containing sulfonic acid groups are preferably those of the formula XI
R⁵ (R⁶)C=C(R⁷)—X—SO₃H (XI)
in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Among these monomers, preference is given to those of the formulae XIa, XIb and/or XIc
H₂C=CH—X—SO₃H (XIa)
H₂C=C(CH₃)—X—SO₃H (XIb)
HO₃S—X—(R⁶)C=C(R⁷)—X—SO₃H (XIc)
in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid (X=—C(O)NH—CH(CH₂CH₃) in formula XIa), 2-acrylamido-2-propanesulfonic acid (X=—C(O)NH—C(CH₃)₂ in formula XIa), 2-acrylamido-2-methyl-1-propanesulfonic acid (X=—C(O)NH—CH(CH₃)CH₂— in formula XIa), 2-methacrylamido-2-methyl-1-propanesulfonic acid (X=—C(O)NH—CH(CH₃)CH₂— in formula XIb), 3-methacrylamido-2-hydroxy-propanesulfonic acid (X=—C(O)NH—CH₂CH(OH)CH₂— in formula XIb), allylsulfonic acid (X=CH₂ in formula XIa), methallylsulfonic acid (X=CH₂ in formula XIb), allyloxybenzenesulfonic acid (X=—CH₂—O—C₆H₄— in formula XIa), methallyloxybenzenesulfonic acid (X=—CH₂—O—C₆H₄— in formula XIb), 2-hydroxy-3-(2-propenyloxy)propanesulfonic acid, 2-methyl-2-propene-1-sulfonic acid (X=CH₂ in formula XIb), styrenesulfonic acid (X=C₆H₄ in formula XIa), vinylsulfonic acid (X not present in formula XIa), 3-sulfopropyl acrylate (X=—C(O)NH—CH₂CH₂CH₂— in formula XIa), 3-sulfopropyl methacrylate (X=—C(O)NH—CH₂CH₂CH₂— in formula XIb), sulfomethacrylamide (X=—C(O)NH— in formula XIb), sulfomethylmethacrylamide (X=—C(O)NH—CH₂— in formula XIb) and water-soluble salts of the acids mentioned.

Useful further ionic or nonionogenic monomers are in particular ethylenically unsaturated compounds. The content of monomers of group iii) in the polymers used in accordance with the invention is preferably less than 20% by weight, based on the polymer. Polymers to be used more preferably consist only of monomers of groups i) and ii).

In summary, particular preference is given to copolymers of
i) unsaturated carboxylic acids of the formula X
   R¹(R²)C═C(R³)COOH (X)
   in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms,
ii) monomers of the formula XI containing sulfonic acid groups
   R⁵(R⁶)C=C(R⁷)—X—SO₃H (XI)
   in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—
iii) optionally further ionic or nonionogenic monomers.

Particularly preferred copolymers consist of
i) one or more unsaturated carboxylic acids from the group of acrylic acid, methacrylic acid and/or maleic acid,
ii) one or more monomers containing sulfonic acid groups of the formulae XIa, XIb and/or XIc:
   H₂C=CH—X—SO₃H (XIa)
   H₂C=C(CH₃)—X—SO₃H (XIb)
   HO₃S—X—(R⁶)C=C(R⁷)—X—SO₃H (XIc)
   in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—
iii) optionally further ionic or nonionogenic monomers.

The copolymers present in the compositions may contain the monomers from groups i) and ii) and optionally iii) in varying amounts, and it is possible to combine any of the representatives from group i) with any of the representatives from group ii) and any of the representatives from group iii). Particularly preferred polymers have certain structural units which are described below.

For example, preference is given to inventive compositions which are wherein they comprise one or more copolymers which contain structural units of the formula XII
—[CH₂—CHCOOH]ₘ—[CH₂—CHC(O)—Y—SO₃H]ₚ— (XII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

These polymers are prepared by copolymerization of acrylic acid with an acrylic acid derivative containing sulfonic acid groups. Copolymerizing the acrylic acid derivative containing sulfonic acid groups with methacrylic acid leads to another polymer, the use of which in the inventive compositions is likewise preferred and which is wherein the compositions comprise one or more copolymers which contain structural units of the formula XIII
—[CH₂—C(CH₃)COOH]ₘ—[CH₂—CHC(O)—Y—SO₃H]ₚ— (XIII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Acrylic acid and/or methacrylic acid can also be copolymerized entirely analogously with methacrylic acid derivatives containing sulfonic acid groups, which changes the structural units within the molecule. Thus, inventive compositions which comprise one or more copolymers which contain structural units of the formula XIV
—[CH₂—CHCOOH]ₘ—[CH₂—C(CH₃)C(O)—Y—SO₃H]ₚ— (XIV)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—, are likewise a preferred embodiment of the present invention, just like compositions which are wherein they comprise one or more copolymers which contain structural units of the formula XV
—[CH₂—C(CH₃)COOH]ₘ—[CH₂—C(CH₃)C(O)—Y—SO₃H]ₚ— (XV)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Instead of acrylic acid and/or methacrylic acid, or in addition thereto, it is also possible to use maleic acid as a particularly preferred monomer from group i). This leads to compositions preferred in accordance with the invention which are wherein they comprise one or more copolymers which contain structural units of the formula XVI
—[HOOCCH—CHCOOH]ₘ—[CH₂—CHC(O)—Y—SO₃H]ₚ— (XVI)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—, and to compositions which are wherein they comprise one or more copolymers which contain structural units of the formula XVII
—[HOOCCH—CHCOOH]ₘ—[CH₂—C(CH₃)C(O)O—Y—SO₃H]ₚ— (XVII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

In summary, preference is given to machine dishwashing detergents according to the invention which comprise, as ingredient b), one or more copolymers which contain structural units of the formulae XII and/or XIII and/or XIV and/or XV and/or XVI and/or XVII
—[CH₂—CHCOOH]ₘ—[CH₂—CHC(O)—Y—SO₃H]ₚ— (XII)
—[CH₂—C(CH₃)COOH]ₘ—[CH₂—CHC(O)—Y—SO₃H]ₚ— (XIII)
—[CH₂—CHCOOH]ₘ—[CH₂—C(CH₃)C(O)—Y—SO₃H]ₚ (XIV)
—[CH₂—C(CH₃)COOH]ₘ—[CH₂—C(CH₃)C(O)—Y—SO₃H]ₚ— (XV)
—[HOOCCH—CHCOOH]ₘ—[CH₂—CHC(O)—Y—SO₃H]ₚ—(XVI)
—[HOOCCH—CHCOOH]ₘ—[CH₂—C(CH₃)C(O)O—Y—SO₃H]ₚ— (XVII)
in which m and p are each a whole natural number between 1 and 2000, and Y is a spacer group which is selected from substituted or unsubstituted aliphatic, aromatic or araliphatic hydrocarbon radicals having from 1 to 24 carbon atoms, preference being given to spacer groups in which Y is —O—(CH₂)ₙ— where n=0 to 4, is —O—(C₆H₄)—, is —NH—C(CH₃)₂— or —NH—CH(CH₂CH₃)—.

In the polymers, some or all of the sulfonic acid groups may be in neutralized form, i.e. the acidic hydrogen atom of the sulfonic acid group may be replaced in some or all of the sulfonic acid groups by metal ions, preferably alkali metal ions and in particular by sodium ions. Corresponding compositions which are wherein the sulfonic acid groups within the copolymer are present in partially or completely neutralized form are preferred in accordance with the invention.

The monomer distribution of the copolymers used in the inventive compositions is, in the case of copolymers which contain only monomers from groups i) and ii), preferably in each case from 5 to 95% by weight of i) or ii), more preferably from 50 to 90% by weight of monomer from group i) and from 10 to 50% by weight of monomer from group ii), based in each case on the polymer.

In the case of terpolymers, particular preference is given to those which contain from 20 to 85% by weight of monomer from group i), from 10 to 60% by weight of monomer from group ii), and from 5 to 30% by weight of monomer from group iii).

The molar mass of the polymers used in the inventive compositions can be varied in order to adapt the properties of the polymers to the desired intended use. Preferred machine dishwasher detergents are wherein the copolymers have molar masses of from 2000 to 200,000 gmol⁻¹, preferably from 4000 to 25,000 gmol⁻¹ and in particular from 5000 to 15,000 gmol⁻¹.

The content of one or more copolymers in the inventive compositions can vary depending on the intended use and desired product performance, and preferred inventive machine dishwashing detergents are wherein they contain the copolymer(s) in amounts of from 0.25 to 50% by weight, preferably from 0.5 to 35% by weight, more preferably from 0.75 to 20% by weight and in particular from 1 to 15% by weight.

As already mentioned above, particular preference is given to using in the inventive compositions both polyacrylates and the above-described copolymers of unsaturated carboxylic acids, monomers containing sulfonic acid groups and optionally further ionic or nonionogenic monomers. The polyacrylates have already been described in detail above. Particular preference is given to combinations of the above-described copolymers containing sulfonic acid groups with polyacrylates of low molar mass, for example in the range between 1000 and 4000 daltons. Such polyacrylates are commercially available under the trade names Sokalan® PA15 and Sokalan® PA25 (BASF).

Also suitable are copolymeric polycarboxylates, especially those of acrylic acid with methacrylic acid and of acrylic acid or methacrylic acid with maleic acid. Particularly suitable copolymers have been found to be those of acrylic acid with maleic acid which contain from 50 to 90% by weight of acrylic acid and from 50 to 10% by weight of maleic acid. Their relative molecular mass, based on free acids, is generally from 2000 to 100,000 g/mol, preferably from 20,000 to 90,000 g/mol and in particular from 30,000 to 80,000 g/mol.

The (co)polymeric polycarboxylates may be used either in the form of powder or in the form of an aqueous solution. The content in the compositions of (co)polymeric polycarboxylates is preferably from 0.5 to 20% by weight, in particular from 3 to 10% by weight.

To improve the water solubility, the polymers may also contain allylsulfonic acids, for example allyloxybenzenesulfonic acid and methallylsulfonic acid, as monomers.

Special preference is also given to biodegradable polymers composed of more than two different monomer units, for example those which contain, as monomers, salts of acrylic acid and of maleic acid and vinyl alcohol or vinyl alcohol derivatives, or which contain, as monomers, salts of acrylic acid and of 2-alkylallylsulfonic acid and sugar derivatives.

Further preferred copolymers have, as monomers, preferably acrolein and acrylic acid/acrylic acid salts or acrolein and vinyl acetate.

As further preferred builder substances, mention should equally be made of polymeric aminodicarboxylic acids, salts thereof or precursor substances thereof. Particular preference is given to polyaspartic acids and the salts and derivatives thereof.

Further suitable builder substances are polyacetals which can be obtained by reacting dialdehydes with polyolcarboxylic acids which have from 5 to 7 carbon atoms and at least 3 hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary, for example acid-catalyzed or enzyme-catalyzed, processes. The hydrolysis products preferably have average molar masses in the range from 400 to 500,000 g/mol. Preference is given to a polysaccharide having a dextrose equivalent (DE) in the range from 0.5 to 40, in particular from 2 to 30, where DE is a common measure of the reducing action of a polysaccharide compared to dextrose, which has a DE of 100. It is also possible to use maltodextrins with a DE between 3 and 20 and dry glucose syrups with a DE between 20 and 37, and also yellow dextrins and white dextrins having relatively high molar masses in the range from 2000 to 30,000 g/mol.

The oxidized derivatives of such dextrins are their reaction products with oxidizing agents which are capable of oxidizing at least one alcohol function of the saccharide ring to the carboxylic acid function. A product oxidized on C₆ of the saccharide ring may be particularly advantageous.

Oxydisuccinates and other derivatives of disuccinates, preferably ethylenediaminedisuccinate, are also further suitable cobuilders. In this case, ethylenediamine N,N′-disuccinate (EDDS) is preferably used in the form of its sodium or magnesium salts. In this connection, preference is also given to glycerol disuccinates and glycerol trisuccinates. Suitable use amounts in zeolite-containing and/or silicate-containing formulations are from 3 to 15% by weight.

Further organic cobuilders which can be used are, for example, acetylated hydroxycarboxylic acids or salts thereof, which may also be present in lactone form and which contain at least 4 carbon atoms and at least one hydroxyl group and a maximum of two acid groups.

A further substance class having cobuilder properties is that of the phosphonates. These are in particular hydroxyalkane- and aminoalkanephosphonates. Among the hydroxyalkanephosphonates, 1-hydroxyethane-1,1-diphosphonate (HEDP) is of particular importance as cobuilder. It is preferably used in the form of the sodium salt, the disodium salt giving a neutral reaction and the tetrasodium salt an alkaline reaction (pH 9). Useful aminoalkanephosphonates are preferably ethylenediaminetetramethylenephosphonate (EDTMP), diethylenetriaminepentamethylenephosphonate (DTPMP) and higher homologs thereof. They are preferably used in the form of the neutrally reacting sodium salts, for example as the hexasodium salt of EDTMP or as the hepta- and octasodium salt of DTPMP. From the class of the phosphonates, preference is given to using HEDP as builder. In addition, the aminoalkanephosphonates have a marked heavy metal-binding capacity. Accordingly, especially when the agents also comprise bleaches, it may be preferable to use aminoalkanephosphonates, especially DTPMP, or mixtures of the phosphonates mentioned.

In addition, it is possible to use all compounds which are capable of forming complexes with alkaline earth metal ions as cobuilders.

In the context of the present application, preferred compositions comprise one or more surfactant(s) from the groups of the anionic, nonionic, cationic and/or amphoteric surfactants.

The anionic surfactants used in acid form are preferably one or more substances from the group of the carboxylic acids, the sulfuric monoesters and the sulfonic acids, preferably from the group of the fatty acids, the fatty alkylsulfuric acids and the alkylarylsulfonic acids. In order to have sufficient surface-active properties, the compounds mentioned should have relatively long-chain hydrocarbon radicals, i.e. have at least 6 carbon atoms in the alkyl or alkenyl radical. Typically, the carbon chain distributions of the anionic surfactants are in the range from 6 to 40, preferably from 8 to 30 and in particular from 12 to 22 carbon atoms.

Carboxylic acids which find use as soaps in detergents in the form of their alkali metal salts are obtained industrially for the most part from native fats and oils by hydrolysis. While the alkaline hydrolysis which was carried out even in the nineteenth century led directly to the alkali metal salts (soaps), the practice today is to use only water for hydrolysis on the industrial scale, which hydrolyzes the fats into glycerol and the free fatty acids. Processes employed on the industrial scale are, for example, hydrolysis in an autoclave or continuous high-pressure hydrolysis. In the context of the present invention, carboxylic acids which can be used in acid form as anionic surfactants are, for example, hexanoic acid (caproic acid), heptanoic acid (enanthic acid), octanoic acid (caprylic acid), nonanoic acid (pelargonic acid), decanoic acid (capric acid), undecanoic acid, etc. Preference is given in the context of the present invention to the use of fatty acids such as dodecanoic acid (lauric acid), tetradecanoic acid (myristic acid), hexadecanoic acid (palmitic acid), octadecanoic acid (stearic acid), eicosanoic acid (arachic acid), docosanoic acid (behenic acid), tetracosanoic acid (lignoceric acid), hexacosanoic acid (cerotic acid), triacotanoic acid (melissic acid), and also the unsaturated species 9c-hexadecenoic acid (palmitoleic acid), 6c-octadecenoic acid (petroselic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid) and 9c,12c,15c-octadecatrienoic acid (linolenic acid). For reasons of cost, preference is given not to using the pure species, but rather technical mixtures of the individual acids, as obtainable from fat hydrolysis. Such mixtures are, for example, coconut oil fatty acid (approx. 6% by weight of C₈, 6% by weight of C₁₀, 48% by weight of C₁₂, 18% by weight of C₁₄, 10% by weight of C₁₆, 2% by weight of C₁₈, 8% by weight of C_{18′}, 1% by weight of C_{18″}), palm kernel oil fatty acid (approx. 4% by weight of C₈, 5% by weight of C₁₀, 50% by weight of C₁₂, 15% by weight of C₁₄, 7% by weight of C₁₆, 2% by weight of C₁₈, 15% by weight of C_{18′}, 1% by weight of C_{18″}), tallow fatty acid (approx. 3% by weight of C₁₄, 26% by weight of C₁₆, 2% by weight of C₁₆, 2% by weight of C₁₇, 17% by weight of C₁₈, 44% by weight of C_{18′}, 3% by weight of C_{18″}, 1% by weight of C_{18″′}), hardened tallow fatty acid (approx. 2% by weight of C₁₄, 28% by weight of C₁₆, 2% by weight of C₁₇, 63% by weight of C₁₈, 1% by weight of C_{18′}), technical oleic acid (approx. 1% by weight of C₁₂, 3% by weight of C₁₄, 5% by weight of C₁₆, 6% by weight of C_{16′}, 1% by weight of C₁₇, 2% by weight of C₁₈, 70% by weight of C_{18′}, 10% by weight of C_{18″}, 0.5% by weight of C_{18′″}), technical palmitic/stearic acid (approx. 1% by weight of C₁₂, 2% by weight of C₁₄, 45% by weight of C₁₆, 2% by weight of C₁₇, 47% by weight of C₁₈, 1% by weight of C_{18′}) and soybean oil fatty acid (approx. 2% by weight of C₁₄, 15% by weight of C₁₆, 5% by weight of C₁₈, 25% by weight of C_{18′}, 45% by weight of C_{18″}, 7% by weight of C_{18′″}).

Sulfuric monoesters of relatively long-chain alcohols are likewise anionic surfactants in their acid form and can be used in the context of the present invention. Their alkali metal salts, especially sodium salts, the fatty alcohol sulfates, are obtainable on the industrial scale from fatty alcohols which are reacted with sulfuric acid, chlorosulfonic acid, amidosulfonic acid or sulfur trioxide to give the alkylsulfuric acids in question and subsequently neutralized. The fatty alcohols are obtained from the fatty acids or fatty acid mixtures in question by high-pressure hydrogenation of the fatty acid methyl esters. The quantitatively most significant industrial process for the preparation of fatty alkyl sulfuric acids is the sulfonation of the alcohols with SO₃/air mixtures in special battery, falling-film or tube bundle reactors.

A further class of anionic surfactant acids which can be used in accordance with the invention is that of the alkyl ether sulfuric acids whose salts, the alkyl ether sulfates, feature higher water solubility and lower sensitivity toward water hardness (solubility of the calcium salts) in comparison to the alkyl sulfates. Like the alkyl sulfuric acids, alkyl ether sulfuric acids are synthesized from fatty alcohols which are reacted with ethylene oxide to give the fatty alcohol ethoxylates in question. Instead of ethylene oxide, it is also possible to use propylene oxide. The subsequent sulfonation with gaseous sulfur trioxide in short-path sulfonation reactors affords yields of above 98% of the alkyl ether sulfuric acids in question.

In the context of the present invention, it is also possible to use alkanesulfonic acids and olefinsulfonic acids as anionic surfactants in acid form. Alkanesulfonic acids may contain the sulfonic acid group in terminally bonded form (primary alkanesulfonic acids) or along the carbon chain (secondary alkanesulfonic acids), but only the secondary alkanesulfonic acids are of commercial significance. They are prepared by sulfochlorination or sulfoxidation of linear hydrocarbons. In the Reed sulfochlorination, n-paraffins are reacted with sulfur dioxide and chlorine with irradiation with UV light to give the corresponding sulfochlorides which on hydrolysis with alkalis directly afford the alkanesulfonates, on reaction with water the alkanesulfonic acids. Since di- and polysulfochlorides and also chlorinated hydrocarbons can occur as by-products of the free-radical reaction in the course of the sulfochlorination, the reaction is typically carried out only up to degrees of conversion of 30% and then terminated.

Another process for the preparation of alkanesulfonic acids is sulfoxidation, in which n-paraffins are reacted with sulfur dioxide and oxygen under irradiation with UV light. In this free-radical reaction, alkylsulfonyl radicals are formed gradually and react further with oxygen to give the alkylpersulfonyl radicals. The reaction with unconverted paraffin affords an alkyl radical and the alkylpersulfonic acid which decomposes into an alkylperoxysulfonyl radical and a hydroxyl radical. The reaction of the two radicals with unconverted paraffin affords the alkylsulfonic acids or water which reacts with alkylpersulfonic acid and sulfur dioxide to give sulfuric acid. In order to keep the yield of the two end products, alkylsulfonic acid and sulfuric acid, very high and to suppress side reactions, this reaction is typically only carried out up to degrees of conversion of 1% and then terminated.

Olefinsulfonates are prepared industrially by the reaction of α-olefins with sulfur trioxide. This forms zwitterions as an intermediate, which cyclize to give sultones. Under suitable conditions (alkaline or acidic hydrolysis), these sultones react to give hydroxyalkanesulfonic acids or alkenesulfonic acids, both of which may likewise be used as anionic surfactant acids.

Alkylbenzenesulfonates as high-performance anionic surfactants have been known since the 1930s. At that time, monochlorination of “kogasin” fractions and subsequent Friedel-Crafts alkylation were used to prepare alkylbenzenes which were sulfonated with oleum and neutralized with sodium hydroxide solution. At the start of the 1950s, alkylbenzenesulfonates were prepared by tetramerizing propylene to give branched α-dodecylene, and the product was converted by a Friedel-Crafts reaction using aluminum trichloride or hydrogen fluoride to tetrapropylenebenzene which was subsequently sulfonated and neutralized. This economic means of preparing tetrapropylenebenzenesulfonates (TPS) led to the breakthrough for this class of surfactant, which subsequently replaced soaps as the main surfactant in detergents.

Owing to the inadequate biodegradability of TPS, there is a need to provide novel alkylbenzenesulfonates which are characterized by improved ecological performance. These requirements are satisfied by linear alkylbenzenesulfonates, which are nowadays almost the only alkylbenzenesulfonates prepared and are denoted by the abbreviation ABS or LAS.

Linear alkylbenzenesulfonates are prepared from linear alkylbenzenes which in turn are obtainable from linear olefins. For this purpose, petroleum fractions are separated on the industrial scale into the n-paraffins of the desired purity using molecular sieves and dehydrogenated to give the n-olefins, resulting in both α- and isoolefins. The resulting olefins are then reacted in the presence of acidic catalysts with benzene to give the alkylbenzenes, the selection of the Friedel-Crafts catalyst having an influence on the isomer distribution of the resulting linear alkylbenzenes: when aluminum trichloride is used, the content of the 2-phenyl isomers in the mixture with the 3-, 4-, 5- and other isomers is approx. 30% by weight; if, on the other hand, the catalyst used is hydrogen fluoride, the content of 2-phenyl isomer can be lowered to approx. 20% by weight. Finally, the linear alkylbenzenes are nowadays sulfonated on the industrial scale with oleum, sulfuric acid or gaseous sulfur trioxide, of which the latter is by far the most significant. For the sulfonation, special film or tube-bundle reactors are used and afford, as the product, 97% by weight alkylbenzenesulfonic acid (ABSA), which can be used as the anionic surfactant acid in the context of the present invention.

The selection of the neutralizing agent makes it possible to obtain a very wide variety of salts, i.e. alkylbenzenesulfonates, from the ABSAs. For economic reasons, preference is given to preparing and using the alkali metal salts and, among these, preferably the sodium salts of ABSA. These can be described by the general formula XVIII: 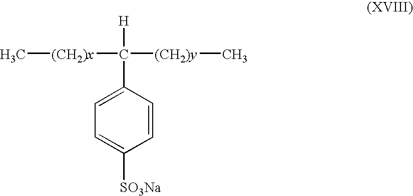
in which the sum of x and y is typically between 5 and 13. Anionic surfactants in acid form which are preferred in accordance with the invention are C₈₋₁₆-alkylbenzene-sulfonic acids, preferably C₉₋₁₃-alkylbenzenesulfonic acids. In the context of the present invention, preference is also given to using C₈₋₁₆-alkylbenzenesulfonic acids, preferably C₉₋₁₃-alkylbenzenesulfonic acids which derive from alkylbenzenes which have a tetralin content below 5% by weight, based on the alkylbenzene. Preference is further given to using alkylbenzenesulfonic acids whose alkylbenzenes have been prepared by the HF process, so that the C₈₋₁₆-alkylbenzenesulfonic acids, preferably C₉₋₁₃-alkylbenzenesulfonic acids used have a content of 2-phenyl isomer below 22% by weight, based on the alkylbenzenesulfonic acid.

The aforementioned anionic surfactants in their acid form may be used alone or in a mixture with one another. However, it is also possible and preferred that further, preferably acidic, ingredients of detergents be added in amounts of from 0.1 to 40% by weight, preferably from 1 to 15% by weight and in particular from 2 to 10% by weight, based in each case on the weight of the mixture to be converted, to the anionic surfactant in acid form before it is added to the carrier material(s).

It will be appreciated that it is also possible to use the anionic surfactants in semineutralized or fully neutralized form. In that case, these salts may be present as a solution, suspension or emulsion in the granulation liquid but may also be part of the fixed bed as a solid. Possible cations for such anionic surfactants are, in addition to the alkali metals (here in particular sodium and potassium salts), ammonium and mono-, di- or triethanolalkonium ions. Instead of mono-, di- or triethanolamine, it is also possible for the analogous representatives of mono-, di- or trimethanolamine or those of the alkanolamines of higher alcohols to be quaternized and to be present, as the cation.

It is advantageously also possible to use cationic surfactants as the active substance. The cationic surfactant may be added directly into the mixer in its supply form, or be sprayed onto the solid support in the form of a liquid to pasty cationic surfactant formulation form. Such cationic surfactant formulation forms can be prepared, for example, by mixing commercial cationic surfactants with assistants such as nonionic surfactants, polyethylene glycols or polyols. It is also possible to use lower alcohols such as ethanol and isopropanol, in which case the amount of such lower alcohols in the liquid cationic surfactant formulation form should, for the abovementioned reasons, be below 10% by weight.

Useful cationic surfactants for the inventive compositions include all customary substances, and there is a distinct preference for cationic surfactants having textile-softening action.

The inventive compositions may comprise, as cationic active substances having textile-softening action, one or more cationic textile-softening agents of the formulae XIX, XX or XXI: 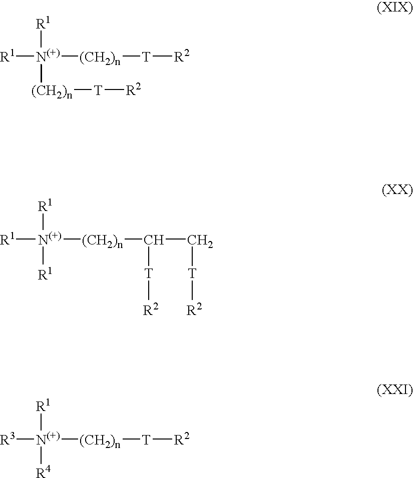
where each R¹ group is independently selected from C₁₋₆-alkyl, -alkenyl or -hydroxyalkyl groups; each R² group is independently selected from C₈₋₂₈-alkyl or -alkenyl groups; R³=R¹ or (CH₂)ₙ-T-R²; R⁴=R¹ or R² or (CH₂)ₙ-T-R²; T=—CH₂—, —O—CO— or —CO—O— and n is an integer from 0 to 5.

In preferred embodiments of the present invention, the composition additionally comprises nonionic surfactant(s) as the active substance.

The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of natural origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

In addition, further nonionic surfactants which may be used are also alkyl glycosides of the general formula RO(G)ₓ in which R is a primary straight-chain or methyl-branched, in particular 2-methyl-branched, aliphatic radical having from 8 to 22, preferably from 12 to 18, carbon atoms and G is the symbol which is a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, are alkoxylated, preferably ethoxylated or ethoxylated and propoxylated, fatty acid alkyl esters, preferably having from 1 to 4 carbon atoms in the alkyl chain, in particular fatty acid methyl esters.

Nonionic surfactants of the amine oxide type, for example N-cocoalkyl-N,N-dimethylamine oxide and N-(tallow alkyl)-N,N-hydroxyethylamine oxide, and of the fatty acid alkanolamide type may also be suitable. The amount of these nonionic surfactants is preferably not more than that of the ethoxylated fatty alcohols, in particular not more than half thereof.

Further suitable surfactants are polyhydroxy fatty acid amides of the formula XXII 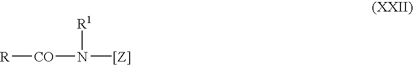
in which RCO is an aliphatic acyl radical having from 6 to 22 carbon atoms, R¹ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can typically be obtained by reductively aminating a reducing sugar with ammonia, an alkylamine or an alkanolamine, and subsequently acylating with a fatty acid, a fatty acid alkyl ester or a fatty acid chloride.

The group of polyhydroxy fatty acid amides also includes compounds of the formula XXIII 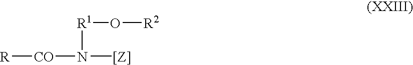
in which R is a linear or branched alkyl or alkenyl radical having from 7 to 12 carbon atoms, R¹ is a linear, branched or cyclic alkyl radical or an aryl radical having from 2 to 8 carbon atoms and R² is a linear, branched or cyclic alkyl radical or an aryl radical or an oxyalkyl radical having from 1 to 8 carbon atoms, preference being given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can be converted to the desired polyhydroxy fatty acid amides by reaction with fatty acid methyl esters in the presence of an alkoxide as catalyst.

It is particularly preferred for many applications when the ratio of anionic surfactant(s) to nonionic surfactant(s) is between 10:1 and 1:10, preferably between 7.5:1 and 1:5 and in particular between 5:1 and 1:2. Preference is given to inventive containers which contain surfactant(s), preferably anionic and/or nonionic surfactant(s), in amounts of from 5 to 80% by weight, preferably of from 7.5 to 70% by weight, more preferably of from 10 to 60% by weight and in particular of from 12.5 to 50% by weight, based in each case on the weight of the enclosed solids.

As already mentioned, the use of surfactants in detergents for machine dishwashing is preferably restricted to the use of nonionic surfactants in small amounts. Inventive compositions for machine dishwashing therefore preferably comprise only certain nonionic surfactants, which are described below. The surfactants used in machine dishwasher detergents are typically only low-foaming nonionic surfactants. Representatives from the groups of the anionic, cationic or amphoteric surfactants are therefore of lesser importance. The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of natural origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

Especially in the case of detergents for machine dishwashing, it is preferred that they comprise a nonionic surfactant which has a melting point above room temperature, preferably a nonionic surfactant having a melting point above 20° C. Nonionic surfactants to be used with preference have melting points above 25° C.; nonionic surfactants to be used with particular preference have melting points between 25 and 60° C., in particular between 26.6 and 43.3° C.

Suitable nonionic surfactants which have melting or softening points in the temperature range specified are, for example, low-foaming nonionic surfactants which may be solid or highly viscous at room temperature. When nonionic surfactants which have a high viscosity at room temperature are used, they preferably have a viscosity above 20 Pas, more preferably above 35 Pas and in particular above 40 Pas. Nonionic surfactants which have a waxlike consistency at room temperature are also preferred.

Nonionic surfactants which are solid at room temperature and are to be used with preference stem from the group of alkoxylated nonionic surfactants, in particular the ethoxylated primary alcohols and mixtures of these surfactants with structurally complex surfactants, such as polyoxypropylene/polyoxyethylene/polyoxypropylene (PO/EO/PO) surfactants. Such (PO/EO/PO) nonionic surfactants are additionally notable for good foam control.

In a preferred embodiment of the present invention, the nonionic surfactant with a melting point above room temperature is an ethoxylated nonionic surfactant which has resulted from the reaction of a monohydroxyalkanol or alkylphenol having from 6 to 20 carbon atoms with preferably at least 12 mol, more preferably at least 15 mol, in particular at least 20 mol, of ethylene oxide per mole of alcohol or alkylphenol.

A nonionic surfactant which is solid at room temperature and is to be used with particular preference is obtained from a straight-chain fatty alcohol having from 16 to 20 carbon atoms (C₁₆₋₂₀-alcohol), preferably a C₁₈-alcohol, and at least 12 mol, preferably at least 15 mol and in particular at least 20 mol, of ethylene oxide. Of these, the “narrow range ethoxylates” (see above) are particularly preferred.

The nonionic surfactant which is solid at room temperature preferably additionally has propylene oxide units in the molecule. Such PO units make up preferably up to 25% by weight, more preferably up to 20% by weight and in particular up to 15% by weight, of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules preferably makes up more than 30% by weight, more preferably more than 50% by weight and in particular more than 70% by weight, of the total molar mass of such nonionic surfactants.

Further nonionic surfactants which have melting points above room temperature and are to be used with particular preference contain from 40 to 70% of a polyoxypropylene/polyoxyethylene/polyoxypropylene block polymer blend which contains 75% by weight of an inverse block copolymer of polyoxyethylene and polyoxypropylene having 17 mol of ethylene oxide and 44 mol of propylene oxide, and 25% by weight of a block copolymer of polyoxyethylene and polyoxypropylene initiated with trimethylolpropane and containing 24 mol of ethylene oxide and 99 mol of propylene oxide per mole of trimethylolpropane.

Nonionic surfactants which can be used with particular preference are obtainable, for example, under the name Poly Tergent® SLF-18 from Olin Chemicals.

A further preferred surfactant can be described by the formula
R¹O[CH₂CH(CH₃)O]ₓ[CH₂CH₂O]_{y}[CH₂CH(OH)R²]
in which R¹ is a linear or branched aliphatic hydrocarbon radical having from 4 to 18 carbon atoms or mixtures thereof, R² is a linear or branched hydrocarbon radical having from 2 to 26 carbon atoms or mixtures thereof, and x is a value between 0.5 and 1.5, and y is a value of at least 15.

Further nonionic surfactants which can be Used with preference are the end group-capped poly(oxyalkylated) nonionic surfactants of the formula
R¹O[CH₂CH(R³)]ₓ[CH₂]ₖCH(OH)[CH₂]ⱼOR²
in which R¹ and R² are linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is a value between 1 and 30, k and j are values between 1 and 12, preferably between 1 and 5. When the value x is ≧2, each R³ in the above formula may be different. R¹ and R² are preferably linear or branched, saturated or unsaturated, aliphatic or aromatic hydrocarbon radicals having from 6 to 22 carbon atoms, particular preference being given to radicals having from 8 to 18 carbon atoms. For the R³ radical, particular preference is given to H, —CH₃ or —CH₂CH₃. Particularly preferred values for x are in the range from 1 to 20, in particular from 6 to 15.

As described above, each R³ in the above formula may be different if x is ≧2. This allows the alkylene oxide unit in the square brackets to be varied. When x is, for example, 3, the R³ radical may be selected so as to form ethylene oxide (R³=H) or propylene oxide (R³=CH₃) units which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x is selected here by way of example and it is entirely possible for it to be larger, the scope of variation increasing with increasing x values and embracing, for example, a large number of (EO) groups combined with a small number of (PO) groups, or vice versa.

Especially preferred end group-capped poly(oxyalkylated) alcohols of the above formula have values of k=1 and j=1, so that the above formula is simplified to
R¹O[CH₂CH(R³)O]ₓCH₂CH(OH)CH₂OR².

In the latter formula, R¹, R² and R³ are each as defined above and x is a number from 1 to 30, preferably from 1 to 20 and in particular from 6 to 18. Particular preference is given to surfactants in which the R¹ and R² radicals have from 9 to 14 carbon atoms, R³ is H and x assumes values of from 6 to 15.

To increase the washing or cleaning performance, inventive compositions may contain enzymes, in which case it is possible in principle to use any enzymes established for these purposes in the prior art. These include in particular proteases, amylases, lipases, hemicellulases, cellulases or oxidoreductases, and preferably mixtures thereof. These enzymes are in principle of natural origin; starting from the natural molecules, improved variants for use in detergents are available and are preferably used accordingly. Inventive compositions preferably contain enzymes in total amounts of from 1×10⁻⁶ to 5 percent by weight based on active protein. The protein concentration may be determined with the aid of known methods, for example the BCA method (bicinchonic acid; 2,2′-biquinolyl-4,4′-dicarboxylic acid) or the biuret method.

Among the proteases, preference is given to those of the subtilisin type. Examples thereof include the subtilisins BPN′ and Carlsberg, protease PB92, the subtilisins 147 and 309, Bacillus lentus alkaline protease, subtilisin DY and the enzymes thermitase and proteinase K which can be classified to the subtilases but no longer to the subtilisins in the narrower sense, and the proteases TW3 and TW7. The subtilisin Carlsberg is available in a developed form under the trade name Alcalase® from Novozymes A/S, Bagsverd, Denmark. The subtilisins 147 and 309 are sold under the trade names Esperase® and Savinase® respectively by Novozymes. The variants listed under the name BLAP® are derived from the protease of Bacillus lentus DSM 5483.

Further examples of useful proteases are the enzymes available under the trade names Durazym®, Relase®, Everlase®, Nafizym, Natalase®, Kannase® and Ovozymes® from Novozymes, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan and that under the name Proteinase K-16 from Kao Corp., Tokyo, Japan.

Examples of amylases which can be used in accordance with the invention are the α-amylases from Bacillus licheniformis, from B. amyloliquefaciens or from B. stearothermophilus and developments thereof which have been improved for use in detergents. The B. licheniformis enzyme is available from Novozymes under the name Termamyl® and from Genencor under the name. Purastar®ST. Development products of this α-amylase are obtainable from Novozymes under the trade names Duramyl® and Termamyl®ultra, from Genencor under the name Purastar®OxAm and from Daiwa Seiko Inc., Tokyo, Japan as Keistase®. The B. amyloliquefaciens α-amylase is sold by Novozymes under the name BAN®, and variants derived from the B. stearothermophilus α-amylase under the names BSG® and Novamyl®, likewise from Novozymes.

Enzymes which should additionally be emphasized for this purpose are the α-amylase from Bacillus sp. A 7-7 (DSM 12368), and the cyclodextrin glucanotransferase (CGTase) from B. agaradherens (DSM 9948); it is equally possible to use fusion products of the molecules mentioned.

Also suitable are the developments of α-amylase from Aspergillus niger and A. oryzae, which are available under the trade names Fungamyl® from Novozymes. Another example of a commercial product is Amylase-LT®.

Inventive compositions may comprise lipases or cutinases, especially owing to their triglyceride-cleaving activities, but also in order to generate peracids in situ from suitable precursors. Examples thereof include the lipases which were originally obtainable from Humicola lanuginosa (Thermomyces lanuginosus) or have been developed, in particular those with the D96L amino acid substitution. They are sold, for example, under the trade names Lipolase®, Lipolase®Ultra, LipoPrime®, Lipozyme®) and Lipex® by Novozymes. It is additionally possible, for example, to use the cutinases which have originally been isolated from Fusarium solani pisi and Humicola insolens. Lipases which are also useful can be obtained under the designations Lipase CE®, Lipase P®, Lipase B®, Lipase CES®, Lipase AKG®, Bacillis sp. Lipase®, Lipase AP®, Lipase M-AP® and Lipase AML® from Amano. Examples of lipases and cutinases from Genencor which can be used are those whose starting enzymes have originally been isolated from Pseudomonas mendocina and Fusarium solanii. Other important commercial products include the M1 Lipase® and Lipomax® preparations originally sold by Gist-Brocades and the enzymes sold under the names Lipase MY-30®, Lipase OF® and Lipase PL® by Meito Sangyo KK, Japan, and also the product Lumafast® from Genencor.

Inventive compositions may, especially when they are intended for the treatment of textiles, comprise cellulases, depending on the purpose either as pure enzymes, as enzyme preparations or in the form of mixtures in which the individual components advantageously complement one another with respect to their different performance aspects. These performance aspects include in particular contributions to the primary washing performance, to the secondary washing performance of the composition (antiredeposition action or graying inhibition) and hand (fabric action), up to exerting a “stone-wash” effect.

A useful fungal, endoglucanase(EG)-rich cellulase preparation and developments thereof are supplied under the trade name Celluzyme® from Novozymes. The products Endolase® and Carezyme®, likewise available from Novozymes, are based on the H. insolens DSM 1800 50 kD EG and 43 kD EG respectively. Further commercial products of this company, which may be used, are Cellusoft® and Renozyme®. It is equally possible to use the Melanocarpus 20 kD EG cellulase, which is available under the trade names Ecostone® and Biotouch® from AB Enzymes, Finland. Further commercial products from AB Enzymes are Econase® and Ecopulp®. A further suitable cellulase from Bacillus sp. CBS 670.93 is available under the trade name Puradex® from Genencor. Other commercial products from Genencor are Genencor detergent cellulase L and IndiAge®Neutra.

Inventive compositions may comprise further enzymes which are combined under the term hemicellulases. These include, for example, mannanases, xanthane lyases, pectin lyases (=pectinases), pectin esterases, pectate lyases, xyloglucanases (=xylanases), pullulanases and β-glucanases. Suitable mannanases are available, for example, under the names Gamanase® and Pektinex AR® from Novozymes, under the name Rohapec® B1L from AB Enzymes and under the name Pyrolase® from Diversa Corp., San Diego, Calif., USA. The β-glucanase obtained from B. subtilis is available under the name Cereflo® from Novozymes.

To enhance the bleaching action, inventive detergents may comprise oxidoreductases, for example oxidases, oxygenases, catalases, peroxidases, such as haloperoxidases, chloroperoxidases, bromoperoxidases, lignin peroxidases, glucose peroxidases or manganese peroxidases, dioxygenases or laccases (phenol oxidases, polyphenol oxidases). Suitable commercial products include Denilite® 1 and 2 from Novozymes. Advantageously, preferably organic, more preferably aromatic, compounds which interact with the enzymes are additionally added in order to enhance the activity of the oxidoreductases concerned (enhancers), or to ensure the electron flux in the event of large differences in the redox potentials of the oxidizing enzymes and the soilings (mediators).

The enzymes used in inventive compositions either stem originally from microorganisms, for example of the genera Bacillus, Streptomyces, Humicola, or Pseudomonas, and/or are produced in biotechnology processes known per se by suitable microorganisms, for instance by transgenic expression hosts of the genera Bacillus or filamentous fungi.

The enzymes in question are favorably purified via processes which are established per se, for example via precipitation, sedimentation, concentration, filtration of the liquid phases, microfiltration, ultrafiltration, the action of chemicals, deodorization or suitable combinations of these steps.

The enzymes may be added to inventive compositions in any form established in the prior art. These include, for example, the solid preparations obtained by granulation, extrusion or lyophilization, or, especially in the case of liquid or gel-form compositions, solutions of the enzymes, advantageously highly concentrated, low in water and/or admixed with stabilizers.

Alternatively, the enzymes may be encapsulated either for the solid or for the liquid administration form, for example by spray-drying or extrusion of the enzyme solution together with a preferably natural polymer, or in the form of capsules, for example those in which the enzymes are enclosed as in a solidified gel, or in those of the core-shell type, in which an enzyme-containing core is coated with a water-, air- and/or chemical-impermeable protective layer. It is possible in layers applied thereto to additionally apply further active ingredients, for example stabilizers, emulsifiers, pigments, bleaches or dyes. Such capsules are applied by methods known per se, for example by agitated or roll granulation or in fluidized bed processes. Advantageously, such granules, for example as a result of application of polymeric film formers, are low-dusting and storage-stable owing to the coating.

It is also possible to formulate two or more enzymes together, so that a single granule has a plurality of enzyme activities.

A protein and/or enzyme present in an inventive composition may be protected, particularly during storage, from damage, for example inactivation, denaturation or decay, for instance by physical influences, oxidation or proteolytic cleavage. When the proteins and/or enzymes are obtained microbially, particular preference is given to inhibiting proteolysis, especially when the compositions also comprise proteases. For this purpose, inventive compositions may comprise stabilizers; the provision of such compositions constitutes a preferred embodiment of the present invention.

One group of stabilizers is that of reversible protease inhibitors. Frequently, benzamidine hydrochloride, borax, boric acids, boronic acids or salts or esters thereof are used, and of these in particular derivatives having aromatic groups, for example ortho-, meta- or para-substituted phenylboronic acids, or the salts or esters thereof. Peptide aldehydes, i.e. oligopeptides with reduced C-terminus are also suitable. Peptidic protease inhibitors which should be mentioned include ovomucoid and leupeptin; an additional option is the formation of fusion proteins of proteases and peptide inhibitors.

Further enzyme stabilizers are amino alcohols such as mono-, di-, triethanol- and -propanolamine and mixtures thereof, aliphatic carboxylic acids up to C₁₂, such as succinic acid, other dicarboxylic acids or salts of the acids mentioned. End group-capped fatty acid amide alkoxylates can also be used as stabilizers.

Lower aliphatic alcohols, but in particular polyols, for example glycerol, ethylene glycol, propylene glycol or sorbitol, are further frequently used enzyme stabilizers. Diglycerol phosphate also protects against denaturation by physical influences. Calcium salts are likewise used, for example calcium acetate or calcium formate, as are magnesium salts.

Polyamide oligomers or polymeric compounds such as lignin, water-soluble vinyl copolymers or cellulose ethers, acrylic polymers and/or polyamides stabilize the enzyme preparation against influences including physical influences or pH fluctuations. Polyamine N-oxide-containing polymers act simultaneously as enzyme stabilizers and as dye transfer inhibitors. Other polymeric stabilizers are the linear C₈-C₁₈ polyoxyalkylenes. Alkylpolyglycosides can likewise stabilize the enzymatic components of the inventive composition and even increase their performance. Crosslinked N-containing compounds fulfill a double function as soil release agents and as enzyme stabilizers.

Reducing agents and antioxidants, such as sodium sulfite or reducing sugars, increase the stability of the enzymes against oxidative decay.

Preference is given to using combinations of stabilizers, for example of polyols, boric acid and/or borax, the combination of boric acid or borate, reducing salts and succinic acid or other dicarboxylic acids or the combination of boric acid or borate with polyols or polyamino compounds and with reducing salts. The action of peptide-aldehyde stabilizers can be increased by the combination with boric acid and/or boric acid derivatives and polyols, and further enhanced by the additional use of divalent cations, for example calcium ions.

Particular preference is given in the context of the present invention to the use of liquid enzyme formulations. Preference is given here to inventive compositions which additionally comprise enzymes and/or enzyme preparations, preferably solid and/or liquid protease preparations and/or amylase preparations, in amounts of from 1 to 5% by weight, preferably of from 1.5 to 4.5% by weight and in particular from 2 to 4% by weight, based in each case on the overall composition.

The electrolytes used from the group of the inorganic salts may be a wide range of highly varying salts. Preferred cations are the alkali metals and alkaline earth metals; preferred anions are the halides and sulfates. From a production point of view, preference is given to the use of NaCl or MgCl₂ in the inventive granules.

In order to bring the pH of solutions of the inventive detergents into the desired range, it may be appropriate to use pH modifiers. It is possible here to use all known acids or alkalis, as long as their use is not forbidden on performance or ecological grounds or on grounds of consumer protection. Typically, the amount of these modifiers does not exceed 1% by weight of the overall formulation.

In the context of the present invention, the perfume oils or fragrances used may be individual odorant compounds, for example the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol and terpineol; the hydrocarbons include primarily the terpenes, such as limonene and pinene. However, preference is given to using mixtures of different odorants which are matched to each other in such a way as together to generate a pleasing fragrance note. Such perfume oils may also contain natural odorant mixtures, as obtainable from vegetable sources, e.g. pine oil, citrus oil, jasmine oil, patchouli oil, rose oil and ylang-ylang oil. Likewise suitable are muscatel, sage oil, chamomile oil, oil of cloves, melissa oil, mint oil, cinnamon leaf oil, lime blossom oil, juniperberry oil, vetiver oil, olibanum oil, galbanum oil and labdanum oil, and orange blossom oil, neroliol, orange peel oil and sandalwood oil.

The general description of the perfumes which can be used (see above) is a general representation of the different classes of odorant substances. In order to be perceptible, an odorant must be volatile, for which an important role is played not only by the nature of the functional groups and by the structure of the chemical compound but also by the molar mass. Thus, the majority of odorants have molar masses of up to about 200 daltons, while molar masses of 300 daltons or more tend to be an exception. On the basis of the different volatility of odorants there is a change in the odor of a perfume or fragrance composed of two or more odorants during its evaporation, and the perceived odors are divided into top note, middle note or body, and end note or dryout. Since the perception of odor is to a large extent also based on the odor intensity, the top note of a perfume or fragrance mixture does not consist only of volatile compounds, whereas the base note consists for the most part of less volatile odorants, i.e., odorants which adhere firmly. In the composition of perfumes it is possible for more volatile odorants, for example, to be bound to certain fixatives, which prevent them from evaporating too: rapidly. The subsequent classification of the odorants into “more volatile” and “firmly adhering” odorants, therefore, states nothing about the perceived odor and about whether the odorant in question is perceived as a top note or as a middle note.

An appropriate selection of the fragrances and perfume oils mentioned can influence both the odor of the water-soluble or water-dispersible container and the odor of the liquid enclosed by it (product fragrance), and also, on completion of the cleaning and care operation, additionally, for example, the odor of the laundry. While more volatile odorants can especially also be used for the influencing of the product fragrance, it is advantageous to use more firmly adhering odorants to achieve an adequate laundry fragrance. Examples of firmly adhering odorants which can be used in the context of the present invention are the essential oils such as angelica root oil, anise oil, arnica blossom oil, basil oil, bay oil, bergamot oil, champaca blossom oil, noble fir oil, noble fir cone oil, elemi oil, eucalyptus oil, fennel oil, spruce needle oil, galbanum oil, geranium oil, ginger grass oil, guaiacwood oil, gurjun balsam oil, helichrysum oil, ho oil, ginger oil, iris oil, cajeput oil, calamus oil, chamomile oil, camphor oil, canaga oil, cardamom oil, cassia oil, pine needle oil, copaiva balsam oil, coriander oil, spearmint oil, caraway oil, cumin oil, lavender oil, lemon grass oil, lime oil, mandarin oil, balm oil, musk seed oil, myrrh oil, clove oil, neroli oil, niaouli oil, olibanum oil, orange oil, origanum oil, palmarosa oil, patchouli oil, Peru balsam oil, petitgrain oil, pepper oil, peppermint oil, pimento oil, pine oil, rose oil, rosemary oil, sandalwood oil, celery oil, spike oil, star anise oil, turpentine oil, thuja oil, thyme oil, verbena oil, vetiver oil, juniperberry oil, wormwood oil, wintergreen oil, ylang-ylang oil, hyssop oil, cinnamon oil, cinnamon leaf oil, citronellol, lemon oil and cypress oil. However, the higher-boiling or solid odorants of natural or synthetic origin may also be used in the context of the present invention as firmly adhering odorants or odorant mixtures, i.e. fragrances. These compounds include the following compounds and mixtures thereof: ambrettolide, α-amylcinnamaldehyde, anethole, anisaldehyde, anisyl alcohol, anisole, methyl anthranilate, acetophenone, benzylacetone, benzaldehyde, ethyl benzoate, benzophenone, benzyl alcohol, benzyl acetate, benzyl benzoate, benzyl formate, benzyl valerate, borneol, bornyl acetate, α-bromostyrene, n-decyl aldehyde, n-dodecylaldehyde, eugenol, eugenol methyl ether, eucalyptol, farnesol, fenchone, fenchyl acetate, geranyl acetate, geranyl formate, heliotropin, methyl heptynecarboxylate, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, coumarin, p-methoxyacetophenone, methyl n-amyl ketone, methyl methylanthranilate, p-methylacetophenone, methylchavicol, p-methylquinoline, methyl α-naphthyl ketone, methyl-n-nonylacetaldehyde, methyl n-nonyl ketone, muscone, P-naphthol ethyl ether, β-naphthol methyl ether, nerol, nitrobenzene, n-nonylaldehyde, nonyl alcohol, n-octylaldehyde, p-oxyacetophenone, pentadecanolide, β-phenylethyl alcohol, phenylacetaldehyde dimethyl acetal, phenylacetic acid, pulegone, safrol, isoamyl salicylate, methyl salicylate, hexyl salicylate, cyclohexyl salicylate, santalol, skatole, terpineol, thymene, thymol, γ-undecalactone, vanillin, veratrum aldehyde, cinnamaldehyde, cinnamyl alcohol, cinnamic acid, ethyl cinnamate, benzyl cinnamate. The more volatile odorants include in particular the lower-boiling odorants of natural or synthetic origin, which may be used alone or in mixtures. Examples of more volatile odorants are alkyl isothiocyanates (alkyl mustard oils), butanedione, limonene, linalool, linalyl acetate and linalyl propionate, menthol, menthone, methyl-n-heptenone, phellandrene, phenylacetaldehyde, terpinyl acetate, citral, citronellal.

In order to improve the esthetic appearance of the enclosed liquid or of the water-soluble container, they may be colored with suitable dyes. Preferred dyes, whose selection presents no difficulty whatsoever to those skilled in the art, have a high storage stability and insensitivity toward the other ingredients of the products and toward light. When the products are used for cleaning textiles, the dyes used should not show marked any substantivity toward textile fibres in order not to color them.

Hydrotropes or solubilizers refer to substances which, by their presence, make other compounds which are virtually insoluble in a certain solvent soluble or emulsifiable in this solvent (solubilization). There are solubilizers which enter into a molecular bond with the sparingly soluble substance and those which act by micelle formation. It can also be said that solubilizers actually impart dissolution power to a “latent” solvent. In the case of water as the (latent) solvent, reference is made usually to hydrotropes instead of solubilizers, and in certain cases it is better to refer to emulsifiers.

Useful foam inhibitors which may be used in the inventive compositions include soaps, oils, fats, paraffins or silicone oils, which may optionally be applied, to support materials. Suitable support materials are, for example, inorganic salts such as carbonates or sulfates, cellulose derivatives or silicates and mixtures of the aforementioned materials. Products which are preferred in the context of the present application comprise paraffins, preferably unbranched paraffins (n-paraffins) and/or silicones, preferably linear polymeric silicones which have the composition according to the scheme (R₂SiO)x and are also referred to as silicone oils. These silicone oils are commonly clear, colorless, neutral, odorless, hydrophobic liquids having a molecular weight between 1000-150,000, and viscosities between 10 and 1,000,000 mPa·s.

Suitable antiredeposition agents, which are also referred to as soil repellents, are, for example, nonionic cellulose ethers, such as methylcellulose and methylhydroxypropylcellulose having a proportion of methoxy groups of from 15 to 30% by weight and of hydroxypropyl groups of from 1 to 15% by weight, based in each case on the nonionic cellulose ethers, and the prior art polymers of phthalic acid and/or terephthalic acid or derivatives thereof, in particular polymers of ethylene terephthalates and/or polyethylene glycol terephthalates or anionically and/or nonionically modified derivatives thereof. Of these, particular preference is given to the sulfonated derivatives of phthalic acid polymers and terephthalic acid polymers.

Optical brighteners (known as “whiteners”) may be added to the inventive compositions in order to eliminate graying and yellowing of the treated textiles. These substances attach to the fibers and bring about brightening and simulated bleaching action by converting invisible ultraviolet radiation to visible longer-wavelength light, in the course of which the ultraviolet light absorbed from sunlight is radiated as pale bluish fluorescence and, together with the yellow shade of the grayed or yellowed laundry, results in pure white. Suitable compounds stem, for example, from the substance classes of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles.

Graying inhibitors have the task of keeping the soil detached from the fiber suspended in the liquor, thus preventing the soil from reattaching. Suitable for this purpose are water-soluble colloids, usually of organic nature, for example the water-soluble salts of polymeric carboxylic acids, size, gelatin, salts of ether sulfonic acids of starch or of cellulose, or salts of acidic sulfuric esters of cellulose or of starch. Water-soluble polyamides containing acidic groups are also suitable for this purpose. In addition, it is possible to use soluble starch preparations, and starch products other than those mentioned above, for example degraded starch, aldehyde starches, etc. It is also possible to use polyvinylpyrrolidone. Also usable as graying inhibitors are cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethyl-cellulose and mixtures thereof.

Since textile fabrics, in particular those made of rayon, viscose, cotton and mixtures thereof, can tend to crease because the individual fibers are sensitive toward bending, folding, compressing and crushing transverse to the fiber direction, the inventive compositions may comprise synthetic anticrease agents. These include, for example, synthetic products based on fatty acids, fatty acid esters, fatty acid amides, fatty acid alkylol esters, fatty acid alkylolamides or fatty alcohols, which have usually been reacted with ethylene oxide, or products based on lecithin or modified phosphoric esters. A substance suitable to a particular degree for textile finishing and care is cottonseed oil which can be produced, for example, by extractively pressing the brown cleaned cottonseeds and refining with about 10% sodium hydroxide or by extracting with hexane at 60-70° C. Such cotton oils contain from 40 to 55% by weight of linoleic acid, from 16 to 26% by weight of oleic acid and from 20 to 26% by weight of palmitic acid. Further particularly preferred products for fiber smoothing and fibercare are the glycerides, especially the monoglycerides of fatty acids, for example glycerol monooleate or glycerol monostearate.

To control microorganisms, the inventive compositions may comprise active antimicrobial ingredients. A distinction is drawn here, depending on the antimicrobial spectrum and mechanism of action, between bacteriostats and bactericides, fungistats and fungicides, etc. Important substances from these groups are, for example, benzalkonium chlorides, alkylarylsulfonates, halophenols and phenylmercuric acetate, although it is also possible to dispense entirely with these compounds in the inventive compositions.

In order to prevent undesired changes, caused by the action of oxygen and other oxidative processes, to the detergents and/or the textiles treated, the inventive compositions may comprise antioxidants. This compound class includes, for example, substituted phenols, hydroquinones, pyrocatechols and aromatic amines, and also organic sulfides, polysulfides, dithiocarbamates, phosphites and phosphonates.

Increased wear comfort can result from the additional use of antistats which are additionally added to the inventive compositions. Antistats increase the surface conductivity and thus permit improved discharge of charges formed. External antistats are generally substances having at least one hydrophilic molecular ligand and impart to the surfaces a more or less hygroscopic film. These usually interface-active antistats can be subdivided into nitrogen antistats (amines, amides, quaternary ammonium compounds), phosphorus antistats (phosphoric esters) and sulfur antistats (alkylsulfonates, alkyl sulfates). Lauryl-(or stearyl)dimethylbenzylammonium chlorides are likewise suitable as antistats for textiles or as additives for detergents, in which case a softening effect is additionally achieved.

Repellency and impregnation processes serve to finish textiles with substances which prevent the deposition of soil or make it easier to wash out. Preferred repellents and impregnating agents are perfluorinated fatty acids, also in the form of their aluminum and zirconium salts, organic silicates, silicones, polyacrylic esters having a perfluorinated alcohol component or polymerizable compounds having a coupled, perfluorinated acyl or sulfonyl radical. Antistats may also be present. The soil-repellent finish with repellents and impregnating agents is often classified as an easycare finish. The penetration of the impregnating agents in the form of solutions or emulsions of the active ingredients in question may be eased by adding wetting agents which lower the surface tension. A further field of use of repellents and impregnating agents is the water-repellent finishing of textiles, tents, tarpaulins, leather, etc., in which, in contrast to waterproofing, the fabric pores are not sealed and the substance thus remains breathable (hydrophobicizing). The hydrophobicizing agents used for the hydrophobicization coat textiles, leather, paper, wood, etc., with a very thin layer of hydrophobic groups such as relatively long alkyl chains or siloxane groups. Suitable hydrophobicizing agents are, for example, paraffins, waxes, metal soaps, etc., with additives of aluminum or zirconium salts, quaternary ammonium compounds having long-chain alkyl radicals, urea derivatives, fatty acid-modified melamine resins, chromium complex salts, silicones, organotin compounds and glutaraldehyde, and also perfluorinated compounds. The hydrophobicized materials do not have a greasy feel, but water drops, similarly to the way they do on greased substances, run off them without wetting them. For example, silicone-impregnated textiles have a soft hand and are water- and soil-repellant. Stains of ink, wine, fruit juices and the like can be removed more easily.
mFor the care of the textiles and for an improvement in the textile properties such as a softer “hand” (softening) and reduced electrostatic charge (increased wear comfort), the inventive compositions may comprise fabric softeners. The active ingredients in fabric softener formulations are ester quats, quaternary ammonium compounds having two hydrophobic radicals, for example distearyldimethylammonium chloride which, however, owing to its inadequate biodegradability, is increasingly being replaced by quaternary ammonium compounds which contain ester groups in their hydrophobic radicals as intended cleavage sites for biodegradation. Such ester quats having improved biodegradability are obtainable, for example, by esterifying mixtures of methyldiethanolamine and/or triethanolamine with fatty acids and subsequently quaternizing the reaction products with alkylating agents in a manner known per se. Another suitable finish is dimethylolethyleneurea.

To improve the water-absorption capacity and the rewettability of the treated textiles, and to ease the ironing of these textiles, it is possible to use silicone derivatives, for example, in the inventive compositions. They additionally improve the rinse-out performance of the inventive compositions by virtue of their foam-inhibiting properties. Preferred silicone derivatives are, for example, polydialkyl- or alkylarylsiloxanes in which the alkyl groups have from one to five carbon atoms and are fully or partly fluorinated. Preferred silicones are polydimethylsiloxanes which may optionally be derivatized and are in that case amino-functional or quaternized or have Si—OH, Si—H and/or Si—Cl bonds. Further preferred silicones are the polyalkylene oxide-modified polysiloxanes, i.e. polysiloxanes which have polyethylene glycols, for example, and the polyalkylene oxide-modified dimethyl polysiloxanes.

Owing to their fibercare action, protein hydrolyzates are further preferred active substances from the field of detergents in the context of the present invention. Protein hydrolyzates are product mixtures which are obtained by acid-, base- or enzyme-catalyzed degradation of proteins. According to the invention, protein hydrolyzates either of vegetable or animal origin may be used. Animal protein hydrolyzates are, for example, elastin, collagen, keratin, silk and milk protein hydrolyzates which may also be present in the form of salts. Preference is given in accordance with the invention to the use of protein hydrolyzates of vegetable origin, for example soya, almond, rice, pea, potato and wheat protein hydrolyzates. Although preference is given to the use of the protein hydrolyzates as such, it is in some cases also possible to use in their stead amino acid mixtures or individual amino acids obtained in other ways, for example arginine, lysine, histidine or pyroglutamic acid. It is likewise possible to use derivatives of protein hydrolyzates, for example in the form of their fatty acid condensates.

Finally, the inventive compositions may also comprise UV absorbers which attach to the treated textiles and improve the photoresistance of the fibers. Compounds which have these desired properties are, for example, the compounds and derivatives of benzophenone having substituents in the 2- and/or 4-position which are active by virtue of radiationless deactivation. Also suitable are substituted benzotriazoles, 3-phenyl-substituted acrylates (cinnamic acid derivatives), optionally having cyano groups in the 2-position, salicylates, organic nickel complexes and natural substances such as umbelliferone and endogenous urocanic acid.

To protect the ware or the machine, detergents for machine dishwashing may comprise corrosion inhibitors, and in particular silver protectants and glass corrosion inhibitors have special significance in the field of machine dishwashing. It is possible to use the known prior art substances. In general, it is possible in particular to use silver protectants selected from the group of the triazoles, the benzotriazoles, the bisbenzotriazoles, the aminotriazoles, the alkylaminotriazoles and the transition metal salts or complexes. Particular preference is given to using benzotriazole and/or alkylaminotriazole. Additionally found in cleaning formulations are frequently active chlorine-containing agents which can distinctly reduce the corrosion of the silver surface. In chlorine-free cleaners, particularly oxygen- and nitrogen-containing organic redox-active compounds are used, such as di- and trivalent phenols, e.g. hydroquinone, pyrocatechol, hydroxyhydroquinone, gallic acid, phloroglucine, pyrogallol or derivatives of these compound classes. Salt- and complex-type inorganic compounds such as salts of the metals Mn, Ti, Zr, Hf, V, Co and Ce frequently also find use. Preference is given here to the transition metal salts which are selected from the group of the manganese and/or cobalt salts and/or complexes, more preferably the cobalt (ammine) complexes, the cobalt (acetate) complexes, the cobalt (carbonyl) complexes, the chlorides of cobalt or manganese and of manganese sulfate, and the manganese complexes
[(Me-TACN)Mn^{IV}(m-0)₃Mn^{IV}(Me-TACN)]²⁺(PF₆⁻)₂,
[(Me-MeTACN)Mn^{IV}(m-0)₃Mn^{IV}(Me-MeTACN)]²⁺(PF₆⁻)₂,
[(Me-TACN)Mn^{III}(m-0)(m-0Ac)₂Mn^{III}(Me-TACN)]²⁺(PF₆⁻)₂ and
[(Me-MeTACN)Mn^{III}(m-0)(m-0Ac)₂Mn^{III}(Me-MeTACN)]²⁺(PF₆⁻)₂, where Me-TACN
is 1,4,7-trimethyl-1,4,7-triazacyclononane and Me-MeTACN is 1,2,4,7-tetramethyl-1,4,7-triazacyclononane. It is likewise possible to use zinc compounds to prevent corrosion of the ware.

In the context of the present invention, preference is given to using at least one silver protectant selected from the group of the triazoles, the benzotriazoles, the bisbenzotriazoles, the aminotriazoles, the alkyl-aminotriazoles, preferably benzotriazole and/or alkylaminotriazole in amounts of from 0.001 to 1% by weight, preferably from 0.01 to 0.5% by weight and in particular from 0.05 to 0.25% by weight; based in each case on the total weight of the solids present in the inventive water-soluble containers.

In addition to the aforementioned silver protectants, inventive compositions may further comprise one or more substances for reducing glass corrosion. In the context of the present application, preference is given especially to additives of zinc and/or inorganic and/or organic zinc salts and/or silicates, for example the sheet-type crystalline sodium disilicate SKS 6 from Clariant GmbH, and/or water-soluble glasses, for example glasses which have a mass loss of at least 0.5 mg under the conditions specified in DIN ISO 719 for the reduction of glass corrosion.

A preferred class of compounds which can be added to the inventive compositions to prevent glass corrosion is that of insoluble zinc salts. These can position themselves during the dishwashing operation on the glass surface, where they prevent metal ions from the glass network from going into solution, and also the silicates from hydrolyzing. Additionally, these insoluble zinc salts also prevent the deposition of silicate on the surface of the glass, so that the glass is protected from the consequences outlined above.

In the context of this preferred embodiment, insoluble zinc salts are zinc salts which have a maximum solubility of 10 grams of zinc salt per liter of water at 20° C. Examples of insoluble zinc salts which are particularly preferred in accordance with the invention are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The zinc compounds mentioned are used in the inventive compositions in amounts which bring about a content of zinc ions in the compositions of between 0.02 and 10% by weight, preferably between 0.1 and 5.0% by weight and in particular between 0.2 and 1.0% by weight, based in each case on the composition without the container. The exact content in the compositions of zinc salt or zinc salts is by its nature dependent on the type of the zinc salts—the less soluble the zinc salt used, the higher its concentration in the inventive compositions should be.

A further preferred class of compounds is that of magnesium and/or zinc salt(s) of at least one monomeric and/or polymeric organic acid. These have the effect that, even upon repeated use, the surfaces of glassware are not altered as a result of corrosion, and in particular no clouding smears or scratches, and also no iridescence of the glass surfaces, are caused.

Even though all-magnesium and/or zinc salt(s) of monomeric and/or polymeric organic acids may be present in accordance with the invention in the claimed compositions, preference is given, as described above, to the magnesium and/or zinc salts of monomeric and/or polymeric organic acids from the groups of the unbranched, saturated or unsaturated monocarboxylic acids, the branched, saturated or unsaturated monocarboxylic acids, the saturated and unsaturated dicarboxylic acids, the aromatic mono-, di- and tricarboxylic acids, the sugar acids, the hydroxy acids, the oxo acids, the amino acids and/or the polymeric carboxylic acids. In the context of the present invention, preference is in turn given within these groups to the acids specified below:

The spectrum of the zinc salts, preferred in accordance with the invention, of organic acids, preferably of organic carboxylic acids, ranges from salts which are sparingly soluble or insoluble in water, i.e. have a solubility below 100 mg/l, preferably below 10 mg/l, in particular have zero solubility, to those salts which have a solubility in water above 100 mg/l, preferably above 500 mg/l, more preferably above 1 g/l and in particular above 5 g/l (all solubilities at water temperature 20° C.). The first group of zinc salts includes, for example, zinc citrate, zinc oleate and zinc stearate; the group of soluble zinc salts includes, for example, zinc formate, zinc acetate, zinc lactate and zinc gluconate.

In a further preferred embodiment of the present invention, the compositions according to the invention comprise at least one zinc salt, but no magnesium salt of an organic acid, preferably at least one zinc salt of an organic carboxylic acid, more preferably a zinc salt from the group of zinc stearate, zinc oleate, zinc gluconate, zinc acetate, zinc lactate and/or zinc citrate. Preference is also given to zinc ricinoleate, zinc abietate and zinc oxalate.

A composition which is preferred in the context of the present invention contains zinc salt in amounts of from 0.1 to 5% by weight, preferably from 0.2 to 4% by weight and in particular from 0.4 to 3% by weight, or zinc in oxidized form (calculated as Zn²⁺) in amounts of from 0.01 to 1% by weight, preferably from 0.02 to 0.5% by weight and in particular from 0.04 to 0.2% by weight, based in each case on the composition without the container.

Particularly preferred compositions comprise at least one zinc salt of an organic acid, preferably selected from the group of zinc oleate, zinc stearate, zinc gluconate, zinc acetate, zinc lactate and zinc citrate.

Detergent compositions which are particularly preferred in the context of the present invention can be determined by means of a modified Olten test. In this modified test, 300 g of the liquid detergent composition at 20° C. are introduced with stirring (laboratory stirrer, 3-blade propeller, 800 rpm) into a solution, at 80° C., of 50 g of sodium sulfate in 200 ml of water in a 1 l cylindrical Dewar (half life: 10 hours), and the temperature change is subsequently determined as a function of time. In this test, preferred liquid detergent compositions are distinguished by a temperature of this solution of less than 72° C., preferably less than 70° C., more preferably less than 68° C. and in particular less than 65° C., five minutes after introduction of 300 g of a sample, at 20° C., of the liquid detergent composition into a solution, at 80° C., of 50 g of sodium sulfate in 200 ml of water.

The inventive liquid detergent compositions are packaged in water-dispersible or water-soluble containers. The appropriate packaging materials are known from the prior art and stem, for example, from the group of (acetalized) polyvinyl alcohol, polyvinylpyrrolidone, polyethylene oxide, gelatin and mixtures thereof.

Particularly preferred inventive portioned detergent compositions are wherein the water-soluble or water-dispersible container comprises one or more water-soluble polymer(s), preferably a material from the group of (optionally acetalized) polyvinyl alcohol (PVAL), polyvinylpyrrolidone, polyethylene oxide, gelatin, cellulose, and derivatives thereof and mixtures thereof.

“Polyvinyl alcohols” (abbreviation PVAL, sometimes also PVOH) is the name for polymers of the general structure 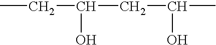
which also comprise structural units of the 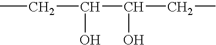
type in small fractions (approx. 2%).

Commercial polyvinyl alcohols, which are supplied as white-yellowish powders or granules with degrees of polymerization in the range from approx. 100 to 2500 (molar masses from approx. 4000 to 100,000 g/mol), have degrees of hydrolysis of 98-99 or 87-89 mol %, and thus also comprise a residual content of acetyl groups. The polyvinyl alcohols are characterized on the part of the manufacturer by specifying the degree of polymerization of the starting polymer, the degree of hydrolysis, the hydrolysis number or the solution viscosity.

Depending on the degree of hydrolysis, polyvinyl alcohols are soluble in water and a few strongly polar organic solvents (formamide, dimethylformamide, dimethyl sulfoxide); they are not attacked by (chlorinated) hydrocarbons, esters, fats and oils. Polyvinyl alcohols are classified as toxicologically uncontroversial and are at least partially biodegradable. The water solubility can be reduced by aftertreatment with aldehydes (acetalization), by complexing with nickel or copper salts or by treatment with dichromates, boric acid or borax. The coatings made of polyvinyl alcohol are largely impenetratable to gases such as oxygen, nitrogen, helium, hydrogen, carbon dioxide, but allow steam to pass through.

In the context of the present invention, it is preferred for the water-soluble or water-dispersible container to comprise a polyvinyl alcohol whose degree of hydrolysis is from 70 to 100 mol %, preferably from 80 to 90 mol %, more preferably from 81 to 89 mol % and in particular from 82 to 88 mol %.

The materials used for the containers are preferably polyvinyl alcohols of a certain molecular weight range, preference being given in accordance with the invention to the water-soluble or water-dispersible container comprising a polyvinyl alcohol whose molecular weight is in the range from 10,000 to 100,000 gmol⁻¹, preferably from 11,000 to 90,000 gmol⁻¹, more preferably from 12,000 to 80,000 gmol⁻¹ and in particular from 13,000 to 70,000 gmol⁻¹.

The degree of polymerization of such preferred polyvinyl alcohols is between about 200 and about 2100, preferably between about 220 and about 1890, more preferably between about 240 and about 1680 and in particular between about 260 and about 1500.

The polyvinyl alcohols described above are widely available commercially, for example under the trade name Mowiol® (Clariant). Polyvinyl alcohols which are particularly suitable in the context of the present invention are, for example, Mowiol® 3-83, Mowiol® 4-88, Mowiol® 5-88 and Mowiol® 8-88.

Further polyvinyl alcohols which are particularly suitable as a material for the container can be taken from the table below:

| | Degree of | Molar mass | Melting point |
|---|---|---|---|
| Name | hydrolysis [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23 600 | 100 |
| Gohsefimer ® LL02 | 41-51 | 17 700 | 100 |

Further polyvinyl alcohols suitable as a material for the container are ELVANOL® 51-05, 52-22, 50-42, 85-82, 75-15, T-25, T-66, 90-50 (trademark of Du Pont), ALCOTEX® 72.5, 78, B72, F80/40, F88/4, F88/26, F88/40, F88/47 (trade mark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trademark of Nippon Gohsei K.K.)

The water solubility of PVAL can be altered by aftertreatment with aldehydes (acetalization) or ketones (ketalization). In this context, particularly preferred polyvinyl alcohols which are particularly advantageous due to their exceptionally good solubility in cold water have been found to be those which are acetalized or ketalized with the aldehyde and keto groups, respectively, of saccharides or polysaccharides or mixtures thereof. The reaction products of PVAL and starch can be used exceptionally advantageously.

In addition, the solubility in water can be altered by complexation with nickel or copper salts or by treatment with dichromates, boric acid, borax, and thus be adjusted selectively to desired values. Films of PVAL are largely impenetratable to gases such as oxygen, nitrogen, helium, hydrogen, carbon dioxide, but allow steam to pass through.

Examples of suitable water-soluble PVAL films are the PVAL films obtainable under the name “SOLUBLON®” from Syntana Handelsgesellschaft E. Harke GmbH & Co. Their solubility in water can be adjusted to a precise degree, and films of this product series are obtainable which are soluble in the aqueous phase in all temperature ranges relevant for the application.

Polyvinylpyrrolidones, referred to for short as PVP, can be described by the following general formula: 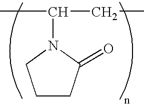
PVPs are prepared by free-radical polymerization of 1-vinylpyrrolidone. Commercially available PVPs have molar masses in the range from approx. 2500 to 750,000 g/mol and are supplied as white, hygroscopic powders or as aqueous solutions.

Polyethylene oxides, PEOX for short, are polyalkylene glycols of the general formula
H—[O—CH₂—CH₂]ₙ—OH
which are prepared industrially by base-catalyzed polyaddition of ethylene oxide (oxirane) in systems containing usually small amounts of water, with ethylene glycol as the starter molecule. They have molar masses in the range from about 200 to 5,000,000 g/mol, corresponding to degrees of polymerization n of from about 5 to >100,000. Polyethylene oxides have an exceptionally low concentration of reactive hydroxyl end groups and exhibit only weak glycol properties.

Gelatin is a polypeptide (molar mass: from approx. 15,000 to >250,000 g/mol) which is obtained primarily by hydrolysis of the collagen present in skin and bones of animals under acidic or alkaline conditions. The amino acid composition of the gelatin corresponds substantially to that of the collagen from which it has been obtained and varies depending on its provenance. The use of gelatin as a water-soluble coating material is extremely widespread, especially in pharmacy in the form of hard or soft gelatin capsules. Owing to its high cost in comparison to the abovementioned polymers, gelatin finds use in the form of films only to a small extent.

In the context of the present invention, preference is also given to inventive compositions whose packaging consists of at least partially water-soluble film composed of at least one polymer from the group of starch and starch derivatives, cellulose and cellulose derivatives, in particular methylcellulose and mixtures thereof.

Starch is a homoglycan, the glucose units being linked α-glycosidically. Starch is made up of two components of different molecular weight: of from approx. 20 to 30% of straight-chain amylose (MW from approx. 50,000 to 150,000) and from 70 to 80% of branched-chain amylopectin (MW from approx. 300,000 to 2,000,000). In addition, small amounts of lipids, phosphoric acid and cations are also present. While the amylose forms long, helical, intertwined chains having from approx. 300 to 1200 glucose molecules owing to the binding in the 1,4-arrangement, the chain branches in the case of amylopectin after, on average, 25 glucose units by a 1,6-bond to give a branch-like structure having from about 1500 to 12,000 molecules of glucose. In addition to pure starch, suitable substances for the preparation of water-soluble coatings of the laundry detergent, dishwasher detergent and cleaning composition portions in the context of the present invention are also starch derivatives which are obtainable from starch by polymer-like reactions. Such chemically modified starches include, for example, products of esterifications or etherifications in which hydroxyl hydrogen atoms have been substituted. However, starches in which the hydroxyl groups have been replaced by functional groups which are not bonded via an oxygen atom can also be used as starch derivatives. The group of starch derivatives includes, for example, alkali metal starches, carboxymethyl starch (CMS), starch esters and starch ethers, and also amino starches.

Pure cellulose has the formal gross composition (C₆H₁₀O₅)ₙ and, considered in a formal sense, constitutes a β-1,4-polyacetal of cellobiose which is itself formed from two molecules of glucose. Suitable celluloses consist of from approx. 500 to 5000 glucose units and accordingly have average molar masses of from 50,000 to 500,000. Cellulose derivatives can also be used in the context of the present invention and are obtainable from cellulose by polymer-like reactions. Such chemically modified celluloses comprise, for example, products of esterifications or etherifications in which hydroxyl hydrogen atoms have been substituted. However, celluloses in which the hydroxyl groups have been replaced by functional groups which are not bonded via an oxygen atom can also be used as cellulose derivatives. The group of cellulose derivatives includes, for example, alkali metal celluloses, carboxymethylcellulose (CMC), cellulose esters and cellulose ethers, and also aminocelluloses. A cellulose derivative used with particular preference as a water-soluble or water-dispersible packaging material is hydroxypropylmethylcellulose (HPMC).

The water-soluble or water-dispersible containers which comprise the inventive compositions may be produced by any process described in the prior art. In preferred embodiments of the present invention, these containers are film pouches, or injection-molded or thermoformed bodies. Preferred inventive detergent compositions are accordingly wherein the water-soluble or water-dispersible container comprises a film and/or an injection-molded part and/or a blow-molded part and/or a thermoformed part.

When the containers selected as a packaging in accordance with the invention are in the form of film pouches, it is preferred that the water-soluble film which forms the pouch has a thickness of from 1 to 150 μm, preferably of from 2 to 100 μm, more preferably of from 5 to 75 μm and in particular of from 10 to 50 μm.

However, when the water-soluble or water-dispersible containers used are injection moldings or thermoformings, the wall of preferred containers has a thickness of from 50 to 300 μm, preferably of from 70 to 200 μm and in particular of from 80 to 150 μm.

A process particularly suitable for the production of inventive water-soluble or water-dispersible containers is injection molding. Injection molding refers to the reshaping of a molding composition in such a way that the composition, contained in a composition cylinder for more than one injection molding operation, is plastically softened under the action of heat and flows under pressure through a die into the cavity of a mold which has been closed beforehand. The process is employed mainly in the case of noncurable molding compositions which solidify in the mold by cooling. Injection molding is a very economical modern process for producing articles shaped without cutting and is particularly suitable for automated mass production. In industrial operation, the thermoplastic molding compositions (powder, particles, cubes, pastes, inter alia) are heated up to liquefaction (up to 180° C.) and then sprayed under high pressure (up to 140 MPa) into closed, two-part, i.e. consisting of die (formerly known as female part) and core (formerly known as male part), preferably water-cooled molds, where they cool and solidify. It is possible to use piston and screw injection-molding machines. Suitable (injection) molding compositions are water-soluble polymers, for example the abovementioned cellulose ethers, pectins, polyethylene glycols, polyvinyl alcohols, polyvinyl-pyrrolidones, alginates, gelatins or starch.

The present application therefore further provides a process for producing a filled water-soluble container, comprising the steps of:
a) injection-molding a container composed of a water-soluble or water-dispersible material,
b) filling the base molding with a liquid detergent composition, comprising a low-water matrix and phosphates dispersed therein,
c) sealing the filled container with a water-soluble or water-dispersible seal unit,
   wherein the dispersed phosphate comprises sodium tripolyphosphate and the phase I fraction of the dispersed sodium tripolyphosphate based on the total weight of the dispersed sodium tripolyphosphate is less than 25% by weight.

The water-soluble or water-dispersible seal unit which is used in step c) to seal the filled container is preferably an injection molding, in which case this molding preferably has the same three-dimensional shape as the base molding. Preference is consequently given in the context of the present invention especially to a process in which the seal unit has the same three-dimensional shape as the container produced in step a).

In a further preferred embodiment of the inventive process described, the seal unit used is a film, in which case this film may, for example, have been processed beforehand to shape it by thermoforming processes. The present application accordingly further preferably provides an aforementioned process, wherein the water-soluble seal unit introduced in step c) is a water-soluble or water-dispersible film.

It is evident from the above remarks that the thickness of the water-soluble outer wall of inventive containers is not necessarily homogeneous, but may vary depending on the production process selected. In the context of the present application, it is preferred that these variations move within the above-specified preferred ranges for the wall thickness of inventive containers.

It is also possible to seal base molding with the seal unit in various ways. Preference is given in the context of the present invention to sealing processes which are based on partial solvation of the surface of the container and/or of the seal unit and/or on heating of the container and/or of the seal unit to a temperature at which they are plastically deformable. Both the partial solvation and the heating are preferably not effected on the entire surface of the container and/or on the entire surface of the seal unit, but rather only in the regions in which the subsequent sealing is to be effected to form a seal seam. The heating of the surface of the container and/or of the seal unit is effected preferably by the use of hot air, hotplates, heated rolls or of radiated heat, preferably laser radiation or other IR sources such as optical fibers. The present application consequently preferably provides an above-described process in which the sealing in step c) is effected by means of fusion bonding.

In addition to the injection molding process described, the rotary die process is particularly suitable for producing inventive compositions, and the term “rotary die process” in the context of the present application also embraces process variants such as the Accogel process, the reciprocating die process by means of a Norton encapsulation machine, the Colton process and the Upjohn process. The term “rotary die process” is accordingly not to be interpreted as restrictive, but rather embraces all process variants known to those skilled in the art which are suitable for producing filled containers using molding rolls.

However, particular preference is given in the context of the present application to an automatic rotary die process by means of two rotating molding rolls, comprising the steps of:
a) feeding two water-soluble or water-dispersible films which are plastically deformable under the influence of solvent and/or the influence of temperature to two molding rolls rotating in the opposite sense, at least one of these molding rolls having depressions in its surface to accommodate the container to be produced which are bounded by struts,
b) applying a solvent to at least one of these films with at least partial solvation of the surface of this film and/or heating of at least one of these films to a temperature at which this film is plastically deformable,
c) optionally thermoforming and/or imprinting and/or allowing at least one of these films to sink into the depressions of the molding roll,
d) introducing a liquid detergent composition comprising a low-water matrix and phosphate dispersed therein,
d) optionally applying an adhesive,
e) joining the two water-soluble films which are plastically deformable under the influence of solvent and/or the influence of temperature together in the intermediate space of the two molding rolls rotating in the opposite sense,
f) adhesion-bonding and/or squeezing the films by the action of force of the struts onto the films with removal of the container,
   wherein the dispersed phosphate comprises sodium tripolyphosphate and the phase I fraction of the dispersed sodium tripolyphosphate based on the total weight of the dispersed sodium tripolyphosphate is less than 25% by weight.

When this process is carried out, it should be noted that the temperatures for the plastic deformation in step b) and the heat sealing can differ markedly. It is generally the case that the temperature selected in steps b) and c) is below the temperatures needed for above-described fusion bonding in the context of the injection molding process. When, for example, HPMC films are used, the temperature for the plastic deformation is preferably from 85 to 90° C., while the fusion bonding is effected in the temperature range of from 150 to 170° C. For PVA films, the temperatures for the plastic deformation are about 150° C., while the fusion bonding is effected within the range from 160 to 200° C. As in the aforementioned cases, the heating of the container materials may be effected by hot air, radiative heat or direct contact with suitable hot plates or heated rolls.

A further process suitable for the production of water-soluble or water-dispersible containers is the thermoforming process, in which the heating, used in typical thermoforming processes, of plastically deformable films may optionally be supplemented/replaced in the context of the present application by an at least partial solvation of these films. The present application therefore further provides a process for producing a water-soluble container, comprising the steps of:
a) feeding a water-soluble or water-dispersible film which is plastically deformable under the influence of solvent and/or the influence of temperature onto a die which has depressions to accommodate the container to be produced,
b) applying a solvent to this film with at least partial solvation of the surface of this film and/or heating this film up to a temperature at which it is plastically deformable,
c) thermoforming and/or imprinting and/or allowing this film to sink into the depressions of the die,
d) loading the film with a liquid detergent composition comprising a low-water matrix and phosphate dispersed therein,
e) feeding a further water-soluble or water-dispersible film and sealing the thermoformed shape with this film,
   wherein the dispersed phosphate comprises sodium tripolyphosphate and the phase I fraction of the dispersed sodium tripolyphosphate based on the total weight of the dispersed sodium tripolyphosphate is less than 25% by weight.

While allowing the plastically deformable film to sink in or imprinting it in step c) of the claimed process constitute suitable procedures for deforming these films, particular preference is nevertheless given in the context of the present application to a process in which the film is thermoformed in step c) under the action of a vacuum onto the plastically deformable film, and the vacuum is preferably preserved until after the completion of the process in step e) and retains the film in the depression.

The sealing of an inventive container in step e) of the aforementioned thermoforming process may, as in the other processes described too, be effected by adhesion bonding or fusion bonding, and both processes may optionally be carried out in combination with additional action of pressure. Suitable adhesives, depending on the composition of the films, are, in addition to the adhesives known to those skilled in the art, likewise solvents, for example water. In a preferred process variant of the latter process, the adhesive is applied to the film preferably after step b) and/or step c) and/or step d).

However, the sealing may also be effected by fusion sealing or the action of pressure. In order to avoid repetitions, with regard to the fusion sealing, reference is made at this point to the comprehensive descriptions in the context of the injection molding and rotary die processes. In a preferred process variant of the thermoforming process, the sealing in step e) is accordingly effected by the action of temperature and/or pressure.

A fourth process particularly suitable for the production of the water-soluble or water-dispersible container is blow-molding. Such a process comprises the steps of:
a) initially forming a premolding from a blow-molding composition based on a water-soluble thermoplastic polymer;
b) blow-molding the premolding to give a hollow body;
c) filling the hollow body with the inventive detergent; and
d) liquid-tight sealing of the blow-molded hollow body.

In a particularly preferred embodiment, the water-soluble or water-dispersible container produced by one of the above-described processes has one or more embossment(s) and/or one or more imprint(s). The solids enclosed in the container may also have such embossments or imprints. The embossment or the imprint may comprise not only inscriptions but also patterns, shapes, etc. In this way, it is possible to identify, for example, all-purpose laundry detergents by a T-shirt symbol, color laundry detergents by a wool symbol, detergents for machine dishwashing by symbols such as glasses, plates, pots, pans, etc. No limits are placed on the creativity of product managers. Suitable inscriptions are, for example, also the name of the product or of the manufacturer.

These water-soluble films may be produced by various production processes. Mention should be made here in principle of blowing, calendering and casting processes. In a preferred process, the films are blown starting from a melt with air through a blowing mandrel to give a tube. In the calendering process which is likewise one of the production processes used with preference, the raw materials plasticized by suitable additives are sprayed to form the films. It may in particular be necessary here to follow the spraying with a drying step. In the casting process which is likewise one of the preferred production processes, an aqueous polymer preparation is placed on a heatable drying roll, cooling is optionally effected after the evaporation of the water and the film is drawn off. If appropriate, this film is additionally powdered before or during the drawing-off.

Useful container materials are in principle all materials which can dissolve fully or partly in the aqueous phase under the given conditions of a wash operation, rinse operation or cleaning operation (temperature, pH, concentration of washing components). The polymer materials may more preferably belong to the groups of (optionally partly acetalized) polyvinyl alcohol, polyvinylpyrrolidone, polyethylene oxide, gelatin, cellulose and derivatives thereof, starch and derivatives thereof, in particular modified starches, and mixtures (polymer blends, composites, coextrudates, etc.) of the materials mentioned—see above. Particular preference is given to gelatin and polyvinyl alcohols, and to the two materials mentioned, each in a composite with starch or modified starch. Inorganic salts and mixtures thereof are also useful as materials for the at least partly water-soluble coating.

Preference is given in accordance with the invention to an embodiment in which the container as a whole is water-soluble, i.e. dissolves fully when it is used as intended in the washing or machine cleaning and the conditions intended for the dissolution are attained. A significant advantage of this embodiment is that the container dissolves at least partially within a practically relevant short time—a few seconds up to 5 min can be specified as a nonlimiting example—under precisely defined conditions in the wash liquor and thus brings the coated contents, i.e. the cleaning material or a plurality of materials, into the liquor in accordance with the requirements.

In another embodiment of the invention which is likewise preferred owing to advantageous properties, the water-soluble container comprises regions which are less readily water-soluble or even water-insoluble or are water-soluble only at higher temperature and regions which are readily water-soluble or are water-soluble at lower temperature. In other words: the container does not consist of a uniform material having the same water solubility in all regions, but rather of materials of different water solubility. A distinction should be drawn between regions of good water solubility on the one hand and regions having less good water solubility, having poor or even zero water solubility, or regions in which the water solubility attains the desired value only at higher temperature or only at another pH or only at an altered electrolyte concentration on the other hand. This may lead to certain regions of the container dissolving while other regions remain intact under adjustable conditions where it is used as intended. Thus, a container provided with pores or holes is formed, into which water and/or liquor can penetrate, dissolve washing, rinsing or cleaning ingredients and flush them out of the container. In the same way, systems in the form of multichamber containers or in the form of containers arranged one inside the other (“onion system”) can also be provided. Thus, it is possible to produce systems having controlled release of the washing, rinsing or cleaning ingredients.

For the design of such systems, the invention is subject to no restrictions. Thus, containers can be provided in which a uniform polymer material comprises small regions of incorporated compounds (for example of salts) which are more rapidly water-soluble than the polymer material. Secondly, it is also possible to mix a plurality of polymer materials having different water solubility (polymer blend), so that the more rapidly soluble polymer material is disintegrated more rapidly by water or the liquor than that which dissolves more slowly under defined conditions.

It corresponds to a particularly preferred embodiment of the invention that the less readily water-soluble regions or regions which are even water-insoluble or regions of the containers which are water-soluble only at higher temperature are made of a material which corresponds chemically substantially to that of the readily water-soluble regions or regions which are water-soluble at lower temperature, but have a higher layer thickness and/or an altered degree of polymerization of the same polymer and/or have a higher degree of crosslinking of the same polymer structure and/or have a higher degree of acetalization (in the case of PVAL, for example with saccharides, polysaccharides such as starch) and/or have a content of water-insoluble salt components and/or have a content of a water-insoluble polymer. Even taking into account the fact that the containers do not dissolve fully, detergent compositions portioned in this way can be provided in accordance with the invention which have advantageous properties in the release of the detergent composition into the particular liquor.

It has been found that problems relating to production arise in the case of the detergent compositions packaged in water-soluble or water-dispersible containers. In the course of the packaging of the detergent compositions into the water-soluble container, fine particles remain stuck to the container and get into the seams which are formed when the container is sealed. As a result of these particles in the seal, the seams in question are not fully impervious toward the atmosphere, which can lead to stability problems in the detergent composition, and to leaks through the seams in question.

In the case of the liquid detergent compositions, it may additionally be the case that the drips or product strings which are included in the seam to be formed are subjected to such thermal stress when a heat-sealing method is used that the composition boils and can lead to further leaks, discolorations or, in the most serious case, even to accidents as a result of thermal decomposition.

Interestingly, a change in the viscosity of the liquid detergent composition does not lead to success; instead it has to be supported by suitable further measures in the product formulation, these measures also leading to improved results irrespective of the viscosity of the compositions.

To avoid these problems, and for the provision of a portioned liquid, i.e. pourable, detergent composition for which the seams of the container consisting of water-dispersible or water-soluble film are impervious toward the atmosphere, it has been found to be advantageous when the portioned aqueous liquid detergent compositions fulfil certain criteria with regard to the size of the particles suspended in the low-water liquid matrix.

In the context of the present invention, preferred detergent compositions are therefore wherein at least 70% by weight, preferably at least 80% by weight, preferentially at least 85% by weight, more preferably at least 90% by weight and in particular at least 95% by weight, of the dispersed phosphate has particle sizes below 200 μm, preferably below 160 μm, more preferably below 120 μm and in particular below 100 μm.

Within the particle size range mentioned, the aforementioned problems of sealing remaining drips or liquid strings into the seam no longer arise. In this context, the at least 70% by weight of the particles and the 200 μm should be regarded as upper limits which result, for example, from the fact that solids used for industrial purposes can also contain small amounts of coarse fractions. However, it is preferred in the context of the present invention to have a very high proportion distinctly above 70% of particles having sizes below 200 μm present in the detergent composition. A proportion of particularly fine particles whose particle sizes are distinctly below 200 μm may likewise be advantageous.

The water-soluble container material is preferably transparent. In the context of this invention, transparency means that the transmittance within the visible spectrum of light (410 to 800 nm) is greater than 20%, preferably greater than 30%, exceptionally preferably greater than 40% and in particular greater than 50%. Thus, as soon as one wavelength of the visible spectrum of light has a transmittance greater than 20%, it should be considered as transparent in the context of the invention.

Inventive portioned detergent compositions which are packaged in transparent containers may comprise a stabilizer as an essential constituent. In the context of the invention, stabilizers are materials which protect the detergent constituents in their water-soluble, transparent containers from decomposition or deactivation by incident light. It has been found that antioxidants, UV absorbers and fluorescent dyes are particularly suitable here.

In the context of the invention, particularly suitable stabilizers are the antioxidants. In order to prevent undesired changes to the formulations caused by incident light and thus free-radical decomposition, the formulations may comprise antioxidants. The antioxidants used may be, for example, phenols, bisphenols and thiobisphenols substituted by sterically hindered groups. Further examples are propyl gallate, butylhydroxytoluene (BHT), butylhydroxyanisole (BHA), t-butylhydroquinone (TBHQ), tocopherol and the long-chain (C₈-C₂₂) esters of gallic acid, such as dodecyl gallate. Other substance classes are aromatic amines, preferably secondary aromatic amines and substituted p-phenylenediamines, phosphorus compounds with trivalent phosphorus, such as phosphines, phosphites and phosphonites, citric acids and citric acid derivatives such as isopropyl citrate, compounds containing enediol groups, known as reductones, such as ascorbic acid and derivatives thereof such as ascorbic acid palmitate, organosulfur compounds such as the esters of 3,3′-thiodipropionic acid with C₁₋₁₈-alkanols, especially C₁₀₋₁₈-alkanols, metal ion deactivators which are capable of complexing the autoxidation-catalyzing metal ions, for example copper, such as nitrilotriacetic acid, and derivatives and mixtures thereof. Antioxidants may be present in the formulations in amounts of up to 35% by weight, preferably up to 25% by weight, more preferably from 0.01 to 20% by weight and in particular from 0.0.3 to 20% by weight.

A further class of stabilizers which can be used with preference is that of the UV absorbers. UV absorbers can improve the photostability of the formulation constituents. They include organic substances (light protection filters) which are capable of absorbing ultraviolet rays and emitting the energy absorbed again in the form of longer-wavelength radiation, for example heat. Compounds which have these desired properties are, for example, the compounds and derivatives of benzophenone having substituents in the 2and/or 4-position which are effective by virtue of radiationless deactivation. Also suitable are substituted benzotriazoles, for example the water-soluble monosodium 3-(2H-benzotriazol-2-yl)₄-hydroxy-5-(methylpropyl)benzenesulfonate (Cibafast® H), 3-phenyl-substituted acrylates (cinnamic acid derivatives), optionally having cyano groups in the 2-position, salicylates, organic nickel complexes and natural substances such as umbelliferone and endogenous urocanic acid. Of particular significance are biphenyl and in particular stilbene derivatives which are available commercially as Tinosorb® FD or Tinosorb® FR ex Ciba. UV-B absorbers include 3-benzylidenecamphor or 3-benzylidenenorcamphor and derivatives thereof, for example 3-(4-methylbenzylidene)camphor; 4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzomalonate; triazine derivatives, for example 2,4,6-trianilino(p-carbo-2′-ethyl-1′-hexyloxy)-1,3,5-triazine and octyltriazone or dioctylbutamidotriazone (Uvasorb® HEB); propane-1,3-diones, for example 1-(4-tert-butylphenyl)-3-(4′-methoxyphenyl)propane-1,3-dione; ketotricyclo(5.2.1.0)decane derivatives. Also suitable are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, for example 4-(2-oxo-3-bornylidenemethyl)benzenesulfonic acid and 2-methyl-5-(2-oxo-3-bornylidene)sulfonic acid and salts thereof.

Useful typical UV-A filters are in particular derivatives of benzoylmethane, for example 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds. The UV-A and UV-B filters can of course also be used in mixtures. In addition to the soluble substances mentioned, insoluble light protection pigments are also suitable for this purpose, specifically finely dispersed, preferably nanoized, metal oxides or salts. Examples of suitable metal oxides are in particular zinc oxide and titanium dioxide and additionally oxides of iron, zirconium, silicon, manganese, aluminum and cerium, and mixtures thereof. The salts used may be silicates (talc), barium sulfate or zinc stearate. The oxides and salts are already used in the form of pigments for skincare and skin-protecting emulsions and decorative cosmetics. The particles should have an average diameter of less than 100 nm, preferably between 5 and 50 nm and in particular between 15 and 30 nm. They may have a spherical shape, although it is also possible to use particles which have an ellipsoidal shape or a shape which deviates in some other way from the spherical form. The pigments may also be surface-treated, i.e. hydrophilicized or hydrophobicized. Typical examples are coated titanium dioxides, for example titanium dioxide T 805 (Degussa) or Eusolex® T2000 (Merck). Suitable hydrophobic coating compositions are in particular silicones and especially trialkoxyoctylsilanes or simethicones. Preference is given to using micronized zinc oxide.

UV absorbers may be present in the detergent compositions in amounts of up to 5% by weight, preferably up to 3% by weight, more preferably from 0.01 to 2.0% by weight and in particular from 0.03 to 1% by weight.

A further class of stabilizers to be used with preference is that of the fluorescent dyes. They include the 4,4′-diamino-2,2′-stilbenedisulfonic acids (flavone acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and pyrene derivatives substituted by heterocycles. Of particular significance in this connection are the sulfonic acid salts of diaminostilbene derivatives, and polymeric fluorescent substances.

Fluorescent substances may be present in the formulations in amounts of up to 5% by weight, preferably up to 1% by weight, more preferably from 0.01 to 0.5% by weight and in particular from 0.03 to 0.1% by weight.
In a preferred embodiment, the aforementioned stabilizers are used in any desired mixtures. The stabilizers are used in amounts of up to 40% by weight, preferably up to 30% by weight, more preferably from 0.01 to 20% by weight, in particular from 0.02 to 5% by weight.

As already mentioned above, inventive portioned detergent compositions may be provided in such a way that the packaging is firstly water-soluble and secondly sealed tight, i.e. isolated from the environment. Two embodiments can be realized in accordance with the invention:

For instance, it corresponds to a preferred embodiment of the invention that the container(s) is/are sealed and comprise(s) at least one gas which does not react with the detergent composition, more preferably in such an amount that the overall pressure within the sealed container(s) is above the external pressure, even more preferably at least 1 mbar above the external pressure. Very particularly preferred embodiments of these portions according to the invention comprise at least one gas which does not react with the detergent composition in such an amount that the overall pressure within the sealed containers is at least 5 mbar, even more preferably at least 10 mbar, most preferably in the range from 10 mbar to 50 mbar, above the external pressure. Very particularly in the case of the preferred embodiments with overall pressure distinctly above the external pressure, it is possible within the containers to distinctly improve the visual appearance, especially of film pouches. The correspondingly packaged compositions have an increased intrinsic stability and impart the appearance of a tightly packed, “powerful” composition. In connection with the present invention, “external pressure” refers to the pressure on the environment side of the containers which acts on the exterior of the containers, specifically at the time at which the containers are filled with in particular at least one gas.

According to the invention, the containers may comprise either one gas or a plurality thereof. In practice, preference is given to charging the containers with one gas owing to the lower costs associated therewith. Preferred detergent composition portions according to the invention comprise, as gas(es), at least one gas which is selected from the group of N₂, noble gas(es), CO₂, N₂O, O₂, H₂, air, gaseous hydrocarbons, very particularly N₂ which is available inexpensively anywhere. The gases mentioned are advantageously inert toward the components of the washing formulation and are therefore also sometimes referred to as “inert gases” in the context of the present invention.

According to a further, likewise preferred embodiment, the container(s) is/are sealed and comprise at least one substance which releases on reaction with water a gas which does not react with the washing formulation(s), in such an amount that the overall pressure within the closed containers rises. Particularly advantageous portions are those in which the at least one substance present in the container(s), on reaction with water, releases the at least one gas in such an amount that the overall pressure within the closed containers rises by at least 1 mbar above the external pressure, preferably by at least 5 mbar, more preferably by a value which is in the range from 5 to 50 mbar higher than the external pressure. This embodiment is particularly advantageous insofar as its production is greatly simplified compared to that embodiment in which the gas is present in the sealed container, since only the at least one substance has to be added which generates at least one gas in the sealed container on contact with moisture/water. Further, any moisture which has penetrated into the container is taken up and converted straight away by the substance which is capable of reaction with water and is therefore no longer able to worsen the quality of the components of the detergent composition. Also conceivable are mixed forms of the portions in which both (at least) one gas in the container and a substance capable of reaction with water are present from the outset.

In a preferred embodiment of the invention, the substance which releases a gas with water is a constituent of the detergent composition and is—even more preferably—a hygroscopic substance which is compatible with the components of the detergent composition. Preference is given to metering such a substance into the water-soluble or water-dispersible container separately from the inventive liquid detergent composition, and this container is preferably sealed only a few seconds, in particular within 10 seconds, after the contact of the gas-releasing substance with the cleaning composition. The release of the gas then increases the internal pressure within the containers to a value above atmospheric pressure and thus achieves the abovementioned advantages.

Examples of such substances are, although this should not be interpreted as a restriction, substances which are selected from the group of substances containing bound hydrogen peroxide, substances containing —O—O— groups, substances containing —O—C—O— groups, hydrides and carbides, and is more preferably a substance which is selected from the group of percarbonates (more preferably sodium percarbonate), persulfates, perborates, peracids, M_{A}M_{B}H₄ where M_{A} is an alkali metal (more preferably Li or Na) (for example LiAlH₄, NaBH₄, NaAlH₄) and MB is B or Al, or is M^{I}₂C₂ or M^{II}C₂, where M^{I} is a monovalent metal and M^{II} is a divalent metal (for example CaC₂).

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

1. A portioned liquid detergent composition in a water-soluble or water-dispersible container, comprising a low-water matrix and phosphate particles dispersed therein, wherein the dispersed phosphate comprises sodium tripblyphosphate comprising less than 25% weight of phase I sodium tripolyphosphate, based on the total weight of the dispersed sodium tripolyphosphate.

2. The detergent composition of claim 1, wherein the dispersed sodium tripolyphosphate comprises less than 20% by weight of phase I sodium tripolyphosphate.

3. The detergent composition of claim 2, wherein the dispersed sodium tripolyphosphate comprises less than 16% by weight of phase I sodium tripolyphosphate.

4. The detergent composition of claim 3, wherein the dispersed sodium tripolyphosphate comprises less than 12% by weight of phase I sodium tripolyphosphate.

5. The detergent composition of claim 4, wherein the dispersed sodium tripolyphosphate comprises less than 10% by weight of phase I sodium tripolyphosphate.

6. The detergent composition of claim 1, having a total phosphate content of 30 to 70% by weight, based on the weight of liquid detergent composition less the weight of the water-soluble or water-dispersible container.

7. The detergent composition of claim 6, having a total phosphate content of 35 to 65% by weight.

8. The detergent composition of claim 7, having a total phosphate content of 40 to 60% by weight.

9. The detergent composition of claim 8, having a total phosphate content of 45 to 55% by weight.

10. The detergent composition of claim 1, wherein the dispersed phosphate comprises, in addition to the sodium tripolyphosphate, one or more further polyphosphates.

11. The detergent composition of claim 1, wherein at least 10% by weight of the dispersed phosphate, based on the total weight of the dispersed phosphate, has a coating.

12. The detergent composition of claim 11, wherein at least 30% by weight of the dispersed phosphate has a coating.

13. The detergent composition of claim 12, wherein at least 50% by weight of the dispersed phosphate has a coating.

14. The detergent composition of claim 13, wherein at least 70% by weight of the dispersed phosphate has a coating.

15. The detergent composition of claim 1, wherein the dispersed polyphosphate comprises a hydrated phosphate having a water of hydration content of 0.5 to 26% by weight, based on the weight of the dispersed hydrated phosphate.

16. The detergent composition of claim 15, wherein the dispersed polyphosphate comprises a hydrated phosphate having a water of hydration content of 1 to 24% by weight.

17. The detergent composition of claim 16, wherein the dispersed polyphosphate comprises a hydrated phosphate having a water of hydration content of 2 to 20% by weight.

18. The detergent composition of claim 1, wherein at least 70% by weight of the dispersed phosphate has particle sizes below 200 μm.

19. The detergent composition of claim 18, wherein at least 80% by weight of the dispersed phosphate has particle sizes below 160 μm.

20. The detergent composition of claim 19, wherein at least 85% by weight of the dispersed phosphate has particle sizes below 120 μm.

21. The detergent composition of claim 20, wherein at least 90% by weight of the dispersed phosphate has particle sizes below 100 μm.

22. The detergent composition of claim 21, wherein at least 95% by weight of the dispersed phosphate has particle sizes below 100 μm.

23. The detergent composition of claim 1, having a total water content of 0.1 to 15% by weight, based on the weight of the detergent less the water-soluble or water-dispersible container.

24. The detergent composition of claim 23, having a total water content of 0.5 to 12% by weight.

25. The detergent composition of claim 24, having a total water content of 1 to 9% by weight.

26. The detergent composition of claim 25, having a total water content of 2 and 6% by weight.

27. The detergent composition of claim 1, comprising a nonaqueous solvent selected from the group consisting of polyethylene glycols, polypropylene glycols, glycerol, glyceryl carbonate, triacetin, ethylene glycol, propylene glycol, propylene carbonate, hexylene glycol, ethanol, n-propanol, and isopropanol.

28. The detergent composition of claim 27, comprising 0.1 to 70% by weight of the nonaqueous solvent(s).

29. The detergent composition of claim 28, comprising 0.5 to 60% by weight of the nonaqueous solvent(s).

30. The detergent composition of claim 29, comprising 1 to 50% by weight of the nonaqueous solvent(s).

31. The detergent composition of claim 30, comprising 2 to 0.40% by weight of the nonaqueous solvent(s).

32. The detergent composition of claim 31, comprising 2.5 to 30% by weight of the nonaqueous solvent(s).

33. The detergent composition of claim 1, wherein the water-soluble or water-dispersible container comprises one or more water-soluble polymers selected from the group consisting of (optionally acetalized) polyvinyl alcohol (PVAL), polyvinylpyrrolidone, polyethylene oxide, gelatin, cellulose, and any derivatives or mixtures thereof.

34. The detergent composition of claim 1, wherein the water-soluble or water-dispersible container comprises a polyvinyl alcohol having a degree of hydrolysis of 70 to 100 mol %.

35. The detergent composition of claim 34, wherein the polyvinyl alcohol has a degree of hydrolysis of 80 to 90 mol %.

36. The detergent composition of claim 35, wherein the polyvinyl alcohol has a degree of hydrolysis of 81 to 89 mol %.

37. The detergent composition of claim 36, wherein the polyvinyl alcohol has a degree of hydrolysis of 82 to 88 mol %.

38. The detergent composition of claim 1, wherein the water-soluble or water-dispersible container comprises a polyvinyl alcohol having a molecular weight of 10,000 to 100,000 gmol⁻¹.

39. The detergent composition of claim 38, wherein the polyvinyl alcohol has a molecular weight of 11,000 to 90,000 gmol⁻¹.

40. The detergent composition of claim 39, wherein the polyvinyl alcohol has a molecular weight of 12,000 to 80,000 gmol⁻¹.

41. The detergent composition of claim 40, wherein the polyvinyl alcohol has a molecular weight of 13,000 to 70,000 gmol⁻¹.

42. The detergent composition of claim 1, wherein the water-soluble or water-dispersible container comprises a film pouch having a film thickness of 1 to 150 μm.

43. The detergent composition of claim 42, wherein the water-soluble or water-dispersible container comprises a film pouch having a film thickness of 2 to 100 μm.

44. The detergent composition of claim 43, wherein the water-soluble or water-dispersible container comprises a film pouch having a film thickness of 5 to 75 μm.

45. The detergent composition of claim 44, wherein the water-soluble or water-dispersible container comprises a film pouch having a film thickness of 0.10 to 50 μm.

46. The detergent composition of claim 1, wherein the water-soluble or water-dispersible container comprises an injection-molded or blow-molded or thermoformed body having a wall thickness of 50 to 300 μm.

47. The detergent composition of claim 46, wherein the water-soluble or water-dispersible container comprises an injection-molded or blow-molded or thermoformed body having a wall thickness of 70 to 200 μm.

48. The detergent composition of claim 47, wherein the water-soluble or water-dispersible container comprises an injection-molded or blow-molded or thermoformed body having a wall thickness of 80 to 150 μm.

49. The detergent composition of claim 1, wherein 300 g of said composition at a temperature of 20° C. introduced into a solution at a temperature of 80° C. of 50 g of sodium sulfate in 200 ml of water lowers the temperature of this solution to less than 72° C. within five minutes.

50. The detergent composition of claim 1, wherein 300 g of said composition at a temperature of 20° C. introduced into a solution at a temperature of 80° C. of 50 g of sodium sulfate in 200 ml of water lowers the temperature of this solution to less than 70° C. within five minutes.

51. The detergent composition of claim 1, wherein 300 g of said composition at a temperature of 20° C. introduced into a solution at a temperature of 80° C. of 50 g of sodium sulfate in 200 ml of water lowers the temperature of this solution to less than 68° C. within five minutes.

52. The detergent composition of claim 1, wherein 300 g of said composition at a temperature of 20° C. introduced into a solution at a temperature of 80° C. of 50 g of sodium sulfate in 200 ml of water lowers the temperature of this solution to less than 65° C. within five minutes.
